(19) United States
(12) Patent Application Publication
(10) Pub. No.: US 2014/0110344 A1
(43) Pub. Date: Apr. 24, 2014

(54) COMPOSITIONS AND METHODS FOR OIL SPILL REMEDIATION

(71) Applicants: George E. Hoag, South Windsor, CT (US); John B. Collins, South Windsor, CT (US); Jeffrey Thomas Ayers, Boerne, TX (US)

(72) Inventors: George E. Hoag, South Windsor, CT (US); John B. Collins, South Windsor, CT (US); Jeffrey Thomas Ayers, Boerne, TX (US)

(21) Appl. No.: 14/124,655

(22) PCT Filed: Jun. 9, 2011
(86) PCT No.: PCT/US11/39827

§ 371 Date: Dec. 6, 2013

(51) Int. Cl. C02F 1/68; C11D 3/39; C11D 3/18; C11D 1/80

(52) U.S. Cl. CPC C02F 1/682; C11D 1/80; C11D 3/3942; C11D 3/188; C11D 3/185
USPC 210/698; 510/365

(57) ABSTRACT

Compositions and methods for remediation of oil spills in a oil spill impacted water environment are described. The methods may further include degrading spilled oil by oxidation or bioremediation.

### BACKGROUND

1. Field of the Invention

The present invention relates to compositions and methods for remediating oil spills, including in marine environments. For example, the invention relates to methods and compositions for removing, dispersing, and destroying or degrading spilled oil from marine environments, such as seawater, beaches (i.e. sand and rocks), plants, vegetation, and wildlife.

2. Background of the Invention

Typical oil spill response actions involve the use of dispersants made from synthetic surfactants that have characteristics of aquatic toxicity, toxicity to marine mammals and are not completely biodegradable and are frequently skin and tissue irritants to marine species. Further typical applications utilize petroleum solvents such as light petroleum distillated or toxic alcohols as cosolvents in a mixture with surfactants.

In open water and shoreline structures or beaches and rocks associated with coastal environments, upon evaporative weathering, the viscosity of spilled oils increases and simply flushing with water is inadequate to remove oils from these systems. In many cases, booms or other types of barriers are used to contain bulk oil spills, but this is only effective immediate to the source of the oil spill. Once the oils are released from the source from a pipeline leak or spill from a ship or other vessel, then the spilled oils can migrate for miles and booms, skimmers and sorbent materials and other types of containment are ineffective.

A quote from a USEPA Oil Spill manual states: “Some countries rely almost exclusively on dispersants to combat oil spills because frequently rough or choppy conditions at sea make mechanical containment and cleanup difficult. However, dispersants have not been used extensively in the United States because of difficulties with application, disagreement among scientists about their effectiveness, and concerns about the toxicity of the dispersed mixtures.”

Surfactants have specific physical properties resulting in decreases in the interfacial tension between different phases (i.e., oil and water) and corresponding micelle formation depending on the hydrophile-lipophile properties of the surfactants. Resultant dispersions of oil and water can be monophasic, biphasic or triphasic systems (Handbook of Detergents, Pat A: Properties, Surfactant Science Series, Volume 82. Editor-in-Chief, Uri Zoeller, Guy Broze, ed. Marcel Dekker, Inc., NY 1999). Surfactant and surfactant-cosolvent systems have particular properties in water resulting in the decrease of interface tension (IFT) with respect to increase surfactant concentrations applied.

Surfactants with differing properties micellularize (disperse) immiscible organic chemicals differently. Diallo, et. al., demonstrated that the micelle partitioning of single compound immiscible phase hydrocarbons varies according to surfactant properties and chemical properties of the hydrocarbons (Diallo et al., Environmental Science and Technology, vol. 24, pp. 1829-1837, 1994). If a different surfactant is used or a different hydrocarbon is emulsified, the extent of emulsification will significantly vary. The extent of the micelle partitioning of specific compounds in crude oil will vary greatly for a given dispersant mixture. Unfortunately, the Swirling Flask Dispersant Effectiveness Test specified in the US National Contingency Plan (NCP) for oil spills uses only a primitive and outdated method of measuring total hydrocarbons dispersed in seawater using dichloromethane extraction followed by UV/VIS spectroscopy at wavelengths of 340, 370, and 400 nm. This method of analysis provides no useful information on the micellularization of specific crude oil fractions, such as one and two ring aromatic fractions that tend to be the most toxic to marine life.

The manner of mixing the crude oil with a pure dispersant prior to adding to seawater greatly affects the dispersant-crude oil effectiveness, and biases dispersant mixtures that have high concentrations of cosolvents present. When dispersants are used to treat oil spills, the dispersant is added to the surface of the oil and to the aqueous phase, which is the opposite of how the Swirling Flask Dispersant Effectiveness Test is conducted. Additionally, without knowledge of what crude fractions are micellurized it is impossible to interpret toxicity test results of mixtures of dispersants and crude oil, also part of the NCP. Researchers also use UV/VIS spectroscopy for the analysis of surfactants alone (Fulle et al., Comparative Toxicity of Oil, Dispersant, and Dispersed Oil to Texas Marine Species. 2001 International Spill Conference, Tampa, Fla., Mar. 26-29, 2001) in water making interference on measurements of actual oil dispersed in the Swirling Flask Dispersant Effectiveness Test subject to significant experimental error. In 1998, researchers from the State of California published modifications to the Swirling Flask Test to include chemical analysis by Gas Chromatography, a closed vessel, addition of oil to a water-dispersant mixture and correction of dispersant contribution when estimating dispersant effectiveness (Blondina et al., Spill Science and Technology Bulletin, vol. 4, no. 3, pp. 177-185, 1998). Using the EPA Swirling Flask Test and simply correcting the UV absorbance contribution of the Corexit 9500 and Corexit 9527 in a positive control blank, the efficacy decreased from 39% to 30% and from 57% to 41%, respectively. When using a GC/FID method of analysis and using a drop wise method of surfactant addition efficacy of Corexit 9500 and Corexit 9527 decreased from 39% to 16% and from 57% to 22%, respectively.

For the existing dispersant used in the response to the recent Deepwater Horizon oil spill in the Gulf of Mexico, Corexit®9527, the Critical Micelle Concentration (CMC) is 382.9 OIL with a surface tension of 23 dynes/cm (mN/m) at 20° C. (Singer et al. Achieves Environmental Contamination and Toxicology, vol. 29, pp. 33-38, 1995). Given the density of Corexit®9527 is reported to be within 0.98 to 1.02, the CMC would be 382.9 mg/L (Nalco Safety Data Sheet, Corexit®EC 9527A, Oct. 15, 2008). Therefore, the test conditions of the Swirling Flask Dispersant Effectiveness Test for Corexit®9527 is run at a single dispersant concentration which is only about 20% of its CMC concentration. While the exact composition of Corexit®9527 is proprietary, some information is published regarding the composition of this product. Corexit®9527 is reported to be composed of 48% of nonionic surfactants, including ethoxylated sorbitan mono- and trioleate, and sorbitan monooleate, about 35% anionic surfactants, including sodium dioctyl sulfosuccinate and about 17% hydrocarbon-based solvent, ethylene glycol monobutyl ether (Fuller et al., Comparative Toxicity of Oil, Dispersant, and Dispersed Oil to Texas Marine Species, 2001 International Spill Conference, Tampa, Fla., Mar. 26-29, 2001). The Nalco MSDS sheet for Corexit®9527 also listed propylene glycol in the 1% to 5% concentration range.

It is well known that glycol ethers such as ethylene glycol monobutyl ether produce toxic metabolites (Fischer et al., Water Research, vol. 39, pp. 2002-2007, 2005), including 2-butoxyacetaldehyde and 2-butoxyacetic acid, production of 2-butoxyacetic acid in human subjects exposed to ethylene glycol monobutyl ether (Johanson et al., Scandinavian Journal Work and Environmental Health, vol. 12, pp. 594-602, 1986) and has been shown to induce hemangiosarcomas in mice (Corthals et al., Toxicological Sciences, vol. 92, no. 2, pp. 378-386, 2006). Biodegradation studies of ethylene glycol monomethyl ether (EGME) demonstrate ready biodegradability in water ((Singer et al. Achieves Environmental Contamination and Toxicology, vol. 29, pp. 33-38, 1995). However, a “dead end” metabolite methoxy acetic acid has been identified as stable and teratogenic. In this study, it was concluded, “that biotic and abiotic wastewater treatment of EGME could generate harmful by-products which should be monitored” (Singer et al. Achieves Environmental Contamination and Toxicology, vol. 29, pp. 33-38, 1995). The Dow Chemical Company, a manufacturer of ethylene glycol monobutyl ether under the trade name Butyl CELLUSOLVE, states in a Product Information Document, Ecological and Toxicological Data of DOW Glycol Ethers that, “Do not dump glycol ethers into any sewers, on the ground, or in any body of water” (Dow Chemical Company, Product Information, Ecological and Toxicological Data of DOW Glycol Ethers, Form No. 170-00761-0304).

### SUMMARY

Embodiments of the invention include methods for remediating a surface water oil spill by applying onto an oil-spill impacted surface water environment a biodegradable composition comprising at least one surfactant. The surfactant may include one or more ethoxylated plant oils, ethoxylated-amidated plant oils, or nonionic alkyl glycoside crosspolymers. The surfactant is applied in an amount sufficient to remediate the spilled oil.

The environment may be marine water, estuarine water, freshwater, or wetlands. The environment may also include shorelines, beaches, rocks, sand, mudflats, and objects within them such as boats, buoys, bridges, docks, and jetties.

In some embodiments, the composition is applied by spraying the composition onto the surface water environment. In some embodiments, the composition is isotonic with the surface water.

In some embodiments, the composition further includes an oxidant. The oxidant may be a persulfate, sodium persulfate, a percarbonate, a peroxide, hydrogen peroxide, ozone, oxygen, and combinations. In some embodiments, the oxidant is hydrogen peroxide.

The composition may further include a biodegradable cosolvent selected from the group consisting of a terpene, a citrus-derived terpene, limonene, d-limonene, and combinations of these.

In some embodiments, the surfactant includes at least one ethoxylated or ethoxylated-amidated plant oil. The surfactant may have two different ethoxylated or ethoxylated-amidated plant oils. The surfactant may have at least three different ethoxylated or ethoxylated-amidated plant oils. The ethoxylated or ethoxylated-amidated plant oil may be, for example, ethoxylated or ethoxylated-amidated forms of castor oil, coconut oil, corn oil, sesame oil, almond oil, cottonseed oil, olive oil, palm oil, peanut oil, safflower oil, soybean oil, or rapeseed oil. In some embodiments, the surfactant includes one or more of ethoxylated coconut oil, ethoxylated castor oil or ethoxylated-amidified coconut oil.

In some embodiments, the composition has at least one nonionic alkyl glycoside crosspolymer. The composition may have at least two different nonionic alkyl glycoside crosspolymers. The alkyl glycoside crosspolymer may be, for example, a crosspolymer of C₈ to C₁₂ alkylglycoside, n-octylglucoside, n-dodecylglucoside, and n-tetradecylglucoside, or n-decylglucoside. The alkyl glycoside may be an alkyl glucoside. In some embodiments, the alkyl glycoside crosspolymer is sorbitan oleate decylglucoside crosspolymer. Different alkyl glycoside crosspolymers may have different structures, different polymer components, or may have the same polymer components, but different hydrophile-lipophile balances. In some embodiments, the surfactant includes two sorbitan oleate decylglucoside crosspolymers with different hydrophile-lipophile balances.

In some embodiments, the surfactant has at least one ethoxylated or ethoxylated-amidated plant oil, and at least one nonionic alkyl glycoside crosspolymer. In some embodiments, the only surfactants in the composition are alkyl glycoside crosspolymers.

In some embodiments, the composition is essentially free of solvent, e.g. it has no solvent added, although trace amounts may be present. As used herein “solvent” generally does not include water. A water containing composition may be considered essentially free of solvent.

In some embodiments, the surfactant includes one or more of ethoxylated coconut oil, ethoxylated castor oil or ethoxylated-amidified coconut oil. The surfactant may further include a sorbitan oleate decylglucoside crosspolymer. The composition may further include hydrogen peroxide.

Embodiments of the invention include compositions for remediating a surface water oil spill. The compositions include water, a surfactant having at least at least one nonionic alkyl glycoside crosspolymer and an optionally salt, a biodegradable cosolvent, oxidant or combinations of these. The compositions may be essentially free of other ingredients other than water, surfactants, and optionally salt, a biodegradable cosolvent, oxidant or combinations of these. The alkyl glycoside crosspolymer may have, for example, a hydrophile-lipophile balance between about 3 and about 12.

In some embodiments, the composition includes salt and the ionic strength of the composition is isotonic with sea or brackish surface water.

In some embodiments, the composition includes a biodegradable cosolvent selected from the group consisting of a terpene, a citrus-derived terpene, limonene, d-limonene, and combinations.

In some embodiments, the composition includes an oxidant. The oxidant may be, for example, a persulfate, sodium persulfate, a percarbonate, a peroxide, hydrogen peroxide, and combinations. In some embodiments, the oxidant is hydrogen peroxide.

In some embodiment, the composition for remediating a surface water oil spill includes at least two nonionic alkyl glycoside crosspolymers with different hydrophile-lipophile balances. The composition may further include at least one ethoxylated plant oil or ethoxylated-amidated plant oil. In some embodiments, composition further includes three ethoxylated plant oils or ethoxylated-amidated plant oils. In all instances, the plant oil may be, for example, castor oil, coconut oil, corn oil, sesame oil, almond oil, cottonseed oil, olive oil, palm oil, peanut oil, safflower oil, soybean oil, and rapeseed oil.

The alkyl glycoside crosspolymer may be, for example, a sorbitan oleate decylglucoside crosspolymer. In some embodiments, the surfactant further includes a second sorbitan oleate decylglucoside crosspolymer with a different hydrophile-lipophile balance. In some embodiments, the surfactant further includes ethoxylated coconut oil. In some embodiments, the surfactant further includes ethoxylated castor oil and ethoxylated-amidified coconut oil. In some embodiments, the composition further includes hydrogen peroxide. In some embodiments, the composition further includes citrus terpene.

Embodiments include compositions for remediating a surface water oil spill having water, a surfactant including at least one ethoxylated plant oil or ethoxylated-amidated plant oil and optionally salt, a biodegradable cosolvent, oxidant, or combinations of these. The plant oil, may be, for example, castor oil, coconut oil, corn oil, sesame oil, almond oil, cottonseed oil, olive oil, palm oil, peanut oil, safflower oil, soybean oil, and rapeseed oil.

In some embodiments, the composition includes salt and the ionic strength of the composition is isotonic with sea or brackish surface water.

In some embodiments, the composition includes an oxidant. In some embodiments, the oxidant is hydrogen peroxide.

In some embodiments, the surfactant may include three different ethoxylated plant oil or ethoxylated-amidated plant oil surfactants. In some embodiments, the surfactant is a mixture of ethoxylated coconut oils; ethoxylated-amidified coconut oils, and ethoxylated castor oils.

In all embodiments, the composition may be a concentrate suitable for dilution to working strength for applying to an oil spill. In all embodiments, the composition may be a working strength solution suitable for applying directly to an oil spill.

Inventive compositions include open water oil dispersants and surface washing agents that promote oil-in-water emulsions without the required use of added petroleum distillates as solvents or cosolvents, or other cosolvent alcohols and ethers. Embodiment formulations include mixtures of plant-based non-ionic surfactants. The surfactant mixtures can be made to be isotonic with salt or brackish water, or of low ionic strength for use in fresh water environments. Also disclosed is the use of a peroxide-based oxidant added to the surfactants, to facilitate oil dispersion and to also promote emulsion aerobic biological degradation, chemical oxidation and photooxidation and photodegradation, or any combination of these processes. These dispersant and surface washing formulations contain biodegradable photosynthetic plant-based surfactants to disperse oil released to aquatic, terrestrial environments and man-made materials and structures, and hydrogen peroxide to help facilitate destruction of the emulsified oil in place. This technical approach enables effective treatment and remediation of released oils and other organic chemicals with densities equal to or less than that of water, in marine and marine shoreline environments, as well as in inland brackish or freshwater lakes, rivers, ponds, impoundments, reservoirs and other bodies of water or riparian environments, coastal or flooded wetland and farmland. This new approach can also be used to clean oil contamination from surface water communicating with storm and/or sanitary sewers, as the surfactants used are biodegradable and derived directly from either plant oils or other plant materials.

This approach can also be used to treat oils that are released or spilled onto roadways, utility conduits, tanks, pipelines, ballasts, machinery, transportation right of ways, buildings, floors, sumps, counter tops, food preparation surfaces, hoods, vents, grease traps, restaurant equipment, and construction materials. The creation of oil-in-water emulsions with plant-based surfactants, without the need for toxic cosolvents creates ideal nano- and micro-scale micellular reactors that can greatly accelerate degradation processes of the oil released to the environment. The incorporation of peroxide species inside or on the surface of the micelle results in faster reaction rates (i.e., biochemical, photochemical or oxidative) than achievable in bulk aqueous or oil phases alone. Rates and extent of oil degradation processes are greatly accelerated when the oil is micellularized in comparison to when the oil is in a continuous oil phase, or in equilibrium solubility of the oil phase and water alone. The formulations disclosed have the added advantage of using biodegradeable plant oil-based surfactants (for example, coconut oil, castor oil, and other plant materials that have very low toxicity so that the product only helps the environment. In addition, the introduction of hydrogen peroxide (H₂O₂) provides for and enhances several oil destruction pathways including chemical oxidation, photooxidation and biological degradation that break down the oil to harmless compounds such as carbon dioxide and water. The use of natural plant materials and oils as the backbone of the surfactants used provides for lower aquatic toxicity. In formulations where a cosolvent or solvent phase is desired, citrus terpenes or other terpenoid compounds may be added.

### BRIEF DESCRIPTION OF THE DRAWINGS

FIG. 1 shows Table 1. Evaluation criteria of VeruSOL®-Marine and selected dispersants.

FIG. 2 shows Table 2. Evaluation criteria of VeruSOL®-Marine 200 and selected dispersants

FIG. 3 shows Table 3. Evaluation criteria of VeruSOL®-Marine 300 and selected dispersants.

FIG. 4 shows VeruSOL®-Marine interfacial tension plot. Tests were conducted at various surfactant concentrations with 34.6 g/L Instant Ocean. Critical Micelle Concentration(CMC) was calculated by intersection of two linear regression lines of best fit.

FIG. 5 shows VeruSOL®-Marine particle size plot. Diamonds indicate VeruSOL® Marine alone. Squares indicate VeruSOL® Marine plus crude oil emulsion.

FIG. 6 shows Total petroleum hydrocarbons vs VeruSOL®-Marine surfactant concentration. Diamonds show TPH (DRO). Squares show TPH (GRO). Triangles show TPH (Total).

FIG. 7 shows LA crude oil+VeruSOL®-Marine at various doses.

FIG. 8 shows aromatic VOCs vs VeruSOL®-Marine surfactant concentration.

FIG. 9 shows PAHs vs VeruSOL®-Marine surfactant concentration.

FIG. 10 shows VeruSOL®-Marine 200 interfacial tension plot.

FIG. 11 shows VeruSOL®-Marine 200 particle size plot. Diamonds indicate VeruSOL® Marine 200 alone. Squares indicate VeruSOL® Marine 200 plus crude oil emulsion.

FIG. 12 shows total petroleum hydrocarbons vs VeruSOL®-Marine 200 concentration. Diamonds show TPH (DRO). Squares show TPH (GRO). Triangles show TPH (Total).

FIG. 13 shows LA crude oil+VeruSOL®-Marine 200.

FIG. 14 shows aromatic VOCs vs VeruSOL®-Marine 200 concentration.

FIG. 15 shows PAHs vs VeruSOL®-Marine 200 concentration.

FIG. 16 shows VeruSOL®-Marine 300 interfacial tension plot.

FIG. 17 shows VeruSOL®-Marine 300 particle size plot. Diamonds indicate VeruSOL® Marine 300 alone. Squares indicate VeruSOL® Marine 300 plus crude oil emulsion.

FIG. 18 shows LA crude oil+VeruSOL®-Marine 300.

FIG. 19 shows total petroleum hydrocarbons vs VeruSOL®-Marine 300 concentration. Diamonds show TPH (DRO). Squares show TPH (GRO). Triangles show TPH (Total).

FIG. 20 shows PAHs vs VeruSOL®-Marine 300 concentration

FIG. 21 shows factors that combine to increase the severity of an oil spill.

FIG. 22 shows the benefits of dispersing oil using composition of the invention.

FIG. 23 shows VeruSOL-Marine™ oil spill dispersion. FIG. 23A shows samples of crude oil in water with increasing concentrations of VeruSOL-Marine™. FIG. 23B shows the same samples after 2 hours of shaker mixing. FIG. 23C shows the samples 2 hours after shaking (total of 4 hours).

FIG. 24 shows oil spill impacted materials treated with VeruSOLVE™-Marine 200HP. FIG. 24A shows USEPA reference crude oil on rocks. FIG. 24B shows the rocks 5 minutes following spray treatment with VeruSOLVE™-Marine 200HP and rinsed with a small amount of water.

FIG. 25 shows Oil Spill impacted materials pretreated with VeruSOLVE™-Marine 200HP. FIG. 25A shows a rock pretreated with one spray of VeruSOLVE™-Marine 200HP before applying crude oil. FIG. 25B shows the rock completely clean after one spray of water.

FIG. 26 shows beach remediation with VeruSOLVE™-Marine 200HP. FIG. 26A shows Florida beach sand. FIG. 26B shows crude oil in water added to the beach sand. FIG. 26C shows crude oil soaked into the beach sand. FIG. 26D shows the beach sand immediately after treatment with VeruSOLVE™-Marine 200HP. FIG. 26E shows the beach sand after continued reaction with VeruSOLVE™-Marine 200HP. FIG. 26F shows the beach sand following treatment with VeruSOLVE™-Marine 200HP.

FIG. 27 shows VeruSOLVE™-Marine 200HP treatment of No. 6 oil residue coating the inside of a 1,000 gallon HDPE tank for 7 months. FIG. 27A shows the tank before treatment. FIG. 27B shows the tank after 5 minutes following spray treatment with VeruSOLVE™-Marine 200HP.

FIG. 28 shows VeruSOLVE™-Marine 200HP treatment of No. 6 oil soaked pipe parts. FIG. 28A shows the parts before treatment. FIG. 28B shows the parts wiped clean minutes after spray treatment with VeruSOLVE™-Marine 200HP.

### DETAILED DESCRIPTION

In describing embodiments, specific terminology is employed for the sake of clarity. However, the invention is not intended to be limited to the specific terminology so selected. A person skilled in the relevant art will recognize that other equivalent parts can be employed and other methods developed without parting from the spirit and scope of the invention. All references cited herein are incorporated by reference as if each had been individually incorporated. For example, PCT Publication WO2009/014697, U.S. Patent Application Publication No. 2008/0207981; PCT Publication WO2009/014697, U.S. Patent Application Publication No. 2010/0227381; PCT Publication WO2009/042223; U.S. Patent Application Publication No. 2010/0209194; PCT Publication WO2009/042224; U.S. Patent Application Publication No. 2010/0185039; PCT Publication WO2009/042228; U.S. Patent Application Publication No. 2010/0232883; PCT Publication WO2009/114145; PCT Publication WO2009/114146; U.S. Patent Application Publication No. 2010/0200501; U.S. Patent Application Publication No. 2010/0110723; PCT Publication WO2011/047059; PCT Publication WO2011/046943; U.S. Patent Application Publication No. 2011/0091283 are hereby incorporated by reference.

Persons of ordinary skill, given the information contained herein and in the attached figures, would be able to apply it in conjunction with the teachings of applications listed herein.

### DEFINITIONS

Terms used herein have their normal meaning as would be understood by persons skilled in the art. By way of example, and not to contradict or alter the generally accepted meanings, certain terms are defined below for clarity.

“Surface water” generally refers to a permanent of ephemeral body of water open to the atmosphere, e.g. oceans, estuaries, lakes, ponds, reservoirs, rivers, etc, as well as wetlands (land saturated with water, such as marshes, swamps, bogs, fens, and mudflats, whether permanent or seasonal). Surface water generally does not include water treatment facilities. A “surface water environment” refers to a surface water body, its margins, such as shorelines and beaches, whether rock, sand, soil, or concrete, as well as manmade objects (such as boats and buoys) and structures associated with the surface water, such docks, bridges, jetties, etc. The surface water environment may be, for example, associated with a body of fresh water (having less than 500 parts per million or less than <0.05% by weight of dissolved salts), marine water or seawater, or estuarine or brackish water. An impacted region of a surface water environment may include the water or shoreline surface to the depth that is impacted by an oil spill.

“Oil spill” encompasses a release, whether intentional or unintentional, of petroleum-based oil to a surface water environment, whether from above or below the surface of the water, such as deep-sea oil wells. Some causes of oil spills include leaks in transport pipes, releases (including accidental) from transport or tanker ships, and leaks from wells (including off-shore and on-shore wells), including deep sea wells. Petroleum oil is rarely naturally released into a surface water environment naturally, but may occur, for example as a result of seismic disturbances that breach an underground oil reservoir. When exposed to the environment, volatile portions of the crude oil may evaporate, leaving a thick sludge or tar, which adheres to surfaces, such as sand, rocks, plants or wildlife and is very difficult to remove. As used herein, an “oil spill impacted” environment is an area of a surface water environment where petroleum oil has spilled or reached.

As used herein, “remediate” means to decrease the negative impact of an oil spill on the surface water environment that is impacted by an oil spill. Remediation may include increasing the solubility of the oil in water, for example, by micellularization or emulsification. Remediating may include dispersing the oil from the oil spill impacted environment. Remediating may also include chemical, photochemical, or biological destruction of the oil, separately, or in combination with dispersing the oil or increasing the solubility of the oil in water.

As used herein, “applying” means introducing the composition into the oil spill impacted environment. Applying may include, for example, spraying, releasing, dropping, pouring, or dumping, so long as it effectively remediates the oil spill. Applying may be done before, during, or after an oil spill contacts a part of a surface water environment.

As used herein, “biodegradable” means degradation of the material into innocuous products by biological means in a relatively short period of time, such as for example, within a day, a week, a month, 6 months, or a year. Biodegradable may be, for example, 60% degraded in 10 days, e.g as defined according to the OCED 301D Ready Biodegradability Test.

A “dispersant” may refer to a material that breaks up oil on the surface of the water into smaller portions, effectively dispersing the oil across a larger volume of water.

“Surfactants” are surface active agents, molecules that have both hydrophilic and lipophilic parts. Surfactant molecules can coagulate into aggregates known as micelles. Micelles are colloidal-sized aggregates. The surfactant concentration at which micelle formation begins is known as the critical micelle concentration (CMC).

As used herein, “increase the solubility” means to increase the amount of petroleum based oil in water. Solubility is defined as the amount (either weight or volume) of petroleum based oil, per unit of water. Solubility of petroleum based oil may be increased by forming micelles or emulsions, such that the overall amount of oil per unit volume increases. Increasing the solubility may, for example, allow oil to be washed from oil-contaminated surfaces such as rocks or beaches.

As used herein, “increase the dispersibility” means to increase the dispersion, or decrease the aggregation of oil in the oil spill impacted environment. In essence, increasing dispersibility allows the oil to be spread over a larger volume of water. Increased dispersion enables more rapid degradation. Dispersion may also be increased by forming micelles or emulsions with the oil which spread over a larger volume of water.

As used herein, “solvent” includes petroleum-based (i.e. hydrocarbon) solvents, alcohols, (including glycols and polyols), ethers, (including glycol ethers), ketone and ester solvents, but does not include water.

The term “alkyl” glycoside includes glycosides with both straight (linear) and branched hydrocarbon chains containing one to fourteen carbon atoms (i.e. 1, 2, 3, 4, 5, 6, 7, 8, 9, 10, 11, 12, 13, or 14 carbon atoms). Glucosides are examples of glycosides. Examples of alkyl groups include methyl (Me), ethyl (Et), decyl (Dec), lauryl (i.e. dodecyl), tetradecyl and so forth.

An “effective amount” encompasses an amount of a material that will bring about remediation. It also encompasses an amount that brings about an increase in the rate of remediation, as compared to the rate that would have obtained had the material not been introduced.

“Activate” means to modify or alter a substance in such a way that the substance is able to perform a function it was unable, or less able, to perform prior to activation. For example, “activation” encompasses the conversion of a persulfate ion into sulfate free radical, which is then able to oxidize other substances in a location.

A “crude oil contaminant” includes petroleum based oils and by-products resulting from an oil spill, either from release from a well, including off-shore and on-shore wells, or during transport, i.e. from a tanker. When exposed to the environment, volatile portions of the crude oil may evaporate, leaving a thick sludge or tar, which adheres to surfaces, such as sand, rocks, plants or wildlife and is very difficult to remove.

In this text, the term “oxidant” includes all oxidizing compounds or compounds that decompose or react to form an oxidizing compound. For example, the term “oxidant” includes solid, liquid, or gaseous compounds that can decompose to liberate oxygen or an oxidizing species. For example, the term “oxidant” includes compounds such as persulfates, percarbonates, peroxides, hydrogen peroxide, and permanganates.

### Compositions

Embodiments of the invention include compositions for remediating a surface water oil spill. The compositions include water, a surfactant having at least at least one nonionic alkyl glycoside crosspolymer and at least one salt, biodegradable cosolvent, oxidant or combinations of these. The compositions may be essentially free of other ingredients other than water, surfactants, and salt, biodegradable cosolvents, oxidant or combinations of these. The alkyl glycoside crosspolymer may have, for example, a hydrophile-lipophile balance between about 3 and about 12.

As used herein, “salt” includes salts naturally occurring in surface water, in approximately the same concentrations as found in the surface water, but predominately sodium chloride. As used herein, “essentially free” means less than about 5% by weight, less than about 3% by weight, less than about 1% by weight, or less than about 0.5% by weight, or less than 0.1% by weight.

In some embodiments, the composition includes salt and the ionic strength of the composition is isotonic with sea or brackish surface water.

In some embodiments, the composition includes a biodegradable cosolvent selected from the group consisting of a terpene, a citrus-derived terpene, limonene, d-limonene, and combinations.

In some embodiments, the composition includes an oxidant. The oxidant may be, for example, a persulfate, sodium persulfate, a percarbonate, a peroxide, hydrogen peroxide and combinations. In some embodiments, the oxidant is hydrogen peroxide.

In some embodiment, the composition for remediating a surface water oil spill includes at least two nonionic alkyl glycoside crosspolymers with different hydrophile-lipophile balances. The composition may further include at least one ethoxylated plant oil or ethoxylated-amidated plant oil. In some embodiments, composition further includes three ethoxylated plant oils or ethoxylated-amidated plant oils. In all instances, the plant oil may be, for example, castor oil, coconut oil, corn oil, sesame oil, almond oil, cottonseed oil, olive oil, palm oil, peanut oil, safflower oil, soybean oil, and rapeseed oil.

The alkyl glycoside crosspolymer may be, for example, a sorbitan oleate decylglucoside crosspolymer. In some embodiments, the surfactant further includes a second sorbitan oleate decylglucoside crosspolymer with a different hydrophile-lipophile balance. In some embodiments, the surfactant further includes ethoxylated coconut oil. In some embodiments, the surfactant further includes ethoxylated castor oil and ethoxylated-amidified coconut oil. In some embodiments, the composition further includes hydrogen peroxide. In some embodiments, the composition further includes citrus terpene.

Embodiments include composition for remediating a surface water oil spill having water, a surfactant including at least one ethoxylated plant oil or ethoxylated-amidated plant oil and at least one salt, a biodegradable cosolvent, oxidant, or combinations of these. The plant oil, may be, for example, castor oil, coconut oil, corn oil, sesame oil, almond oil, cottonseed oil, olive oil, palm oil, peanut oil, safflower oil, soybean oil, and rapeseed oil.

In some embodiments, the composition includes salt and the ionic strength of the composition is isotonic with sea or brackish surface water.

In some embodiments, the composition includes an oxidant. In some embodiments, the oxidant is hydrogen peroxide.

In some embodiments, the surfactant may include three different ethoxylated plant oil or ethoxylated-amidated plant oil surfactants. In some embodiments, the surfactant is a mixture of ethoxylated coconut oils; ethoxylated-amidified coconut oils, and ethoxylated castor oils.

In all embodiments, the composition may be a concentrate suitable for dilution to working strength for applying to an oil spill. In all embodiments, the composition may be a working strength solution suitable for applying directly to an oil spill.

Ethoxylated or Ethoxylated-Amidated Plant Oil.

In all embodiments having an ethoxylated or ethoxylated-amidated plant oil, the plant oil may be, for example, castor oil, coconut oil, corn oil, sesame oil, almond oil, cottonseed oil, olive oil, palm oil, peanut oil, safflower oil, soybean oil, and rapeseed oil. As understood in the art, an ethoxylated plant oil is a plant oil treated with ethylene oxide to produce a poly(ethyleneglycol) derivative of the plant oil. An amidified plant oil is a plant oil that has been treated to have an amide group, for example, by creating a monoalkanolamide or dialkanolamide of the plant oil. An ethoxylated-amidified plant oil is an amidified plant oil treated with ethylene oxide to produce a polye(ethyleneglycol) derivative of the amidified plant oil. Examples include ethoxylated coconut oil, ethoxylated castor oil, ethoxylated cocoamide (ethoxylated-amidified coconut oil).

In some embodiments, the ethoxylated or ethoxylated-amidated plant oil may having an average of 3 to 36 repeating ethylene glycol (EG) groups. The ethoxylated or ethoxylated-amidated plant oil may have, for example, an average of 6 to 12 repeating ethylene glycol groups, an average of 3 to 9 repeating ethylene glycol groups, or an average of 12 to 36 repeating ethylene glycol groups. The ethoxylated or ethoxylated-amidated plant oil may have, for example, an average of: 6 to 12 EG groups, 8-10 EG groups, or 9 EG groups. The ethoxylated or ethoxylated-amidified plan oil may have, for example, an average of: 12 to 36 EG groups, 20 to 36 EG groups, 30 to 36 EG groups or 36 EG. The ethoxylated or ethoxylated-amidified plant oil may have, for example, an average of: 3 to 9 EG groups, 4 to 8 EG groups, or 6 EG groups.

In some embodiments, the ethoxylate or ethoxylated-amidified plaint oil may have a hydrophile-lipophile balance (HLB) between about 10 and about 16. The HLB may be, for example, above about 10, above about 11, above about 12, or above about 13. The HLB may be, for example, less than about 16, less than about 15, or less than about 14. The HLB may be about 13. When mixtures of ethoxylated or ethoxylated-amidified plant oils are used, the HLB of the mixture may be in the same ranges listed above.

Nonionic Alkyl Glycoside Crosspolymers.

As used herein nonionic alkyl glycoside crosspolymers are uncharged. Alkyl glycoside crosspolymers are crosspolymers formed from alkylated sugar molecules (alkylglycoside) and usually one or more other comonomer. Said sugars may be plant-derived, for example, from corn starch, corn sugar, sugar beets or cane sugar. Example alkyl glycosides include decylglucoside, laurylglucoside. Example alkyl glycoside crosspolymers include, for example, decylglucoside crosspolymers, such as sorbitan oleate decyglucoside crosspolymers. Different alkyl glycoside crosspolymers may have different HLB, but the same basic structure or may have different structures. For example, sorbitan oleate decylglucoside crossoplymers with different HLB are considered different alkyl glycoside crosspolymers.

Concentrations.

As used herein, all percentage concentrations are by weight, unless otherwise specified. Where more than one surfactant is present in a concentrate the amount of each surfactant may be, for example, more than about 10%, more than about 15%, more than about 20%, more than about 25% or more than about 30%.

Any compositions described herein may be a concentrate or working strength solution. Concentrates are typically diluted in water prior to application. As used herein, concentrates have less than about 20% water by weight, less than about 15% water by weight, less than about 10% water by weight, less than 5% water by weight, or less than 2% water by weight. Working strength solutions have greater than about 50% water by weight, greater than about 55% water by weight, greater than about 60% water by weight, greater than about 65% water by weight, greater than about 70% water by weight, greater than about 75% water by weight, greater than about 80% water by weight, greater than about 85%, greater than about 90%, greater than about 95%, greater than about 99%, or greater than 99.9% water by weight.

Where two surfactants are present in a concentrate, the amount of each surfactant may be, for example, more than about 10%, more than about 15%, more than about 20%, more than about 25%, more than about 30%, more than about 35% or more than about 40%. The amount of each surfactant may be less than about 80%, less than about 75%, less than about 70%, less than about 65%, less than about 60%, or less than about 55%.

Where three surfactants are present in a concentrate, the amount of each surfactant may be, for example, more than about 5%, more than about 10%, more than about 15%, more than about 20% or more than 25%. The amount of each surfactant may be, for example, less than about 60%, less than about 55%, less than about 50%, less than about 45%, less than about 40%, or less than about 35%.

Where more than three surfactants are present in a concentrate, the amount of each may be, for example, more than about than about 5%, more than about 10%, more than about 15%, more than about 20% or more than 25%. The amount of each surfactant may be, for example, less than about 60%, less than about 55%, less than about 50%, less than about 45%, less than about 40%, or less than 35%.

Cosolvent.

According to some embodiments, compositions described herein can contain a plant-based biodegradable cosolvent such as a terpene, a citrus-derived terpene, limonene, d-limonene, and combinations thereof. In a working strength solution, the plant-based cosolvent may have a concentration of greater than about 0.1%, greater than about 0.2%, greater than about 0.3%, greater than about 0.4%, or greater than about 0.5%. In a working strength solution, the plant-based cosolvent may have a concentration less than about 10%, less than about 7%, less than about 5%, or less than about 3%.

Oxidant.

According to some embodiments of the invention, the oxidant is a chemical oxidant such as a permanganate, an alkali metal permanganate, potassium permanganate, molecular oxygen, ozone, a persulfate, an alkali metal persulfate, sodium persulfate, an activated persulfate, a percarbonate, an activated percarbonate, a peroxide, an alkali earth peroxide, calcium peroxide, or hydrogen peroxide, or ultraviolet (uV) light or any combination of these oxidants with or without uV light. Additional oxidants and details regarding the same are described in the aforementioned U.S. Published Patent Application No. 2008/0207981.

The overall rate of oxidation can be controlled by controlling the concentration of oxidant. For example, if a greater mass of oxidant is introduced into a given volume, then the concentration of oxidant in that volume will be greater and the rate of oxidation will be faster. On the other hand, if a lesser mass of oxidant is introduced into a given volume, then the concentration of oxidant in that volume will be lesser and the rate of oxidation will be slower. The overall oxidation rate can be controlled by selection of the specific oxidant used, as well as the concentration of the oxidant.

Any composition described herein can have hydrogen peroxide added. In a working strength solution, hydrogen peroxide may have a concentration greater than about 1%, greater than about 2%, greater than about 3%, greater than about 4% or greater than about 5%. In a working strength solution, hydrogen peroxide may have a concentration less than about 10%, less than about 8%, or less than about 6%.

Activator.

According to an exemplary embodiment of the invention, the activator may include a metal, a transition metal, a chelated metal, a complexed metal, a metallorganic complex, and hydrogen peroxide. Examples of activators which are other external agents or conditions include heat, temperature, and high pH. Examples of activators include a metal, iron, Fe(II), Fe(III), a metal chelate, an iron chelate, iron-EDTA, Fe(II)-EDTA, Fe(III)-EDTA, iron-citric acid, Fe(II)-citric acid, Fe(III)-citric acid, zero valent iron, such as nanoscale zero valent iron (e.g., zero valent iron particles having a diameter in the range of from about 1, 2, 5, 10, 20, 50, 100, 200, or 500 nm to about 2, 5, 10, 20, 50, 100, 200, 500, or 1000 nm), hydrogen peroxide, high pH, and heat. In some cases an alkali metal EDTA compound, such as sodium EDTA, may serve as an activator. Additional activators and details regarding the same are described in the aforementioned U.S. Published Patent Application No. 2008/0207981. In other embodiments, the activator may be an Fe-TAML compound. Fe-TAML compounds are described, for example, in U.S. Pat. Nos. 5,847,120, 5,876,625, 6,011,152, 6,051,704, 6,054,580, 6,099,586, 6,100,394, 6,136,223, 6,241,779, and 7,060,818 which are incorporated by reference in their entirety. The activator activates the oxidant, producing free radicals and increasing the rate of oxidation of the crude oil contaminant.

The design basis of surfactant systems in this invention are as follows:
Should not contain petroleum or ether-based solvents or cosolvents;
Should be compatible and not rapidly degraded by chemical oxidants;
Should with the addition of hydrogen peroxide or other peroxide species, such as organic peroxides, result in acceleration of emulsification, dispersion, collection, or hydrocarbon degradation processes, beyond that of the surfactant-emulsified hydrocarbons alone;
Should form nano- and micro-scale micellular emulsions that result in the acceleration of dispersion, collection, or hydrocarbon degradation processes;
Should not contain hazardous substances or materials and the precautionary principle should apply;
Should not result in sinking the oil, but should keep the affected hydrocarbons exposed to sunlight where natural degradation processes are most effective (i.e., natural photooxidation, photodegradation and aerobic biodegradation);
Should be biodegradable and plant-based to the greatest extent possible to ensure complete biodegradation pathways, and not biodegrade into stable or more toxic intermediary compounds;
Should work effectively over a wide range of hydrocarbon species and concentration;
Should not be toxic to humans and other mammals; Should have minimum toxicity to aquatic organisms and should decrease toxicity of hydrocarbon compounds; and
Should be effective across a wide range of application scenarios, and a wide range of natural and man-made environments and materials.

Some specific embodiments are described below.

Formulation-Type 1

This formulation contains at least three non-ionic ethoxylated plant oil or ethoxylated-amidated plant oil based surfactants that have been designed to strictly emulsify oil into stable oil-in-water emulsions. In this system the crude oil compounds are inside the hydrophobic tail of the surfactant molecules with water being the continuous phase at the head of the surfactant molecules. In some embodiments, it is made of three to six non-ionic plant oil-based surfactants and can be made isotonic with a marine aquatic environment, as needed. These components are either Generally Recognized as Safe (GRAS) by the United States Food and Drug Administration the (USFDA) or are approved as indirect food additives and for dermal contact, such as cosmetics. This surfactant system was selected based on its USFDA GRAS status, uses as indirect food additive products, biodegradability, and ability to bring hydrocarbons into an oil-in-water microemulsion versus an oil-water globule mixture.

In some embodiments, the ionic strength can be adjusted to match the receiving water being treated and to develop optimal dosing tests using the ionic composition of the water that is being impacted by the oil. Salinity is a key master variable governing aquatic life. Therefore, to minimize ecological harm caused by the use of dispersants, the salinity or the dispersant mixture may be adjusted to a desired specified value of a particular aquatic system.

In some embodiments, Formulation-type 1 can contain a plant-based cosolvent such as a citrus terpene or various terpenoid compounds. Some formulations contain no solvents or cosolvents other than water.

The overall HLB range of Formulation-type 1 may be about 10 to about 15, about 12 to about 14, or about 13.

In specific embodiments, the three surfactants used in Formulation-type 1 include the following: 1) polyetheylene glycol (PEG) coco fatty acid (ethoxylated coconut oil) having 6 to 12 PEG groups, 8 to 10 PEG groups, or 9 PEG groups. The Hydrophile-Lipophile Balance (HLB) range for the PEG coco fatty acid is about 10 to about 16, about 12 to about 14, or about 13; 2) PEG Castor Oil (ethoxylated castor oil) having 12 to 36 PEG groups, 20 to 36 PEG groups, 30 to 36 PEG groups, or 36 PEG groups. The Hydrophile-Lipophile Balance (HLB) range for the PEG Castor Oil may be, for example, about 10 to about 16, about 12 to about 14, or about 13; 3) PEG Cocamide (ethoxylated-amidified coconut oil) having 3 to 9 PEG groups, 4 to 8 PEG groups, or 6 PEG groups. The Hydrophile-Lipophile Balance (HLB) range for the PEG Castor Oil is about 10 to about 16, about 12 to about 14, or about 13.

Formulation 1 for the application of an open water oil spill may result in a dispersed oil that keeps the dispersed oil shallow so it will minimally sink, enables natural degradation processes to take place efficiently because of the oil-water stable colloidal suspension, works over a wide range of concentrations, emulsifies toxic aromatic compounds, is safe for workers to handle and come into contact with, does not result in any additional vapor phase materials associated with the dispersant, has no known hazardous components or toxic intermediary compounds, is compatible with hydrogen peroxide, can be made isotonic with seawater and has an aquatic toxicity profile similar to other formulations on the National Contingency Plan (NCP) list for surface water dispersants and surface washing agents.

Formulation-Type 2.

These formulations contain mixtures of 1 to 3 non-ionic ethoxylated plant oil based surfactants with 1 to 3 nonionic alkyl glycoside crosspolymer surfactants. Some formulations have 1 non-ionic ethoxylated plant oil based surfactant and 1 nonionic alkyl glycoside crosspolymer.

In some embodiments, Formulation-type 2 can contain a plant-based cosolvent such as a citrus terpene or various terpenoid compounds. In some embodiments, Formulation-type 2 may contain no solvents or cosolvents other than water.

Formulation-type 2 has been designed to emulsify oil into an oil-in-water emulsion and to create an additional water in oil emulsion phase, when used at higher concentrations. In this biphasic system, one phase consists of the crude oil compounds inside the micelle, associated with the hydrophobic tail of the surfactant molecules with water being the continuous phase at the head of the surfactant molecules. The second phase consists of the crude oil compounds outside of the micelle as the continuous phase and water is inside of the micelle associated with the hydrophilic head of the surfactant molecules. In this way, at higher concentrations of surfactant application there can be two phases present a dispersed phase in water and a floating emulsified phase of the oil. This is complementary to skimming and cleaning operations.

The two surfactant types (non-ionic ethoxylated plant oil based surfactant and nonionic alkyl glycoside crosspolymer surfactant) in this formulation are either Listed as Indirect Additives used in Food Contact by the United States Food and Drug Administration the (USFDA) or are approved as for dermal contact, such as cosmetics. Similar to Formulation 1, Formulation 2 was designed based on its USFDA status, uses as indirect food additive products, biodegradability, and ability to bring hydrocarbons into an oil-in-water microemulsion but also to form a continuous floating oil-emulsion phase.

Formulation-type 2 was developed to keep the dispersed oil shallow or floating, enable natural degradation processes to take place efficiently, work over a wide range of concentrations, emulsify toxic aromatic compounds, is safe for workers to handle and come into contact with, does not result in any vapor phase materials associated with the dispersant, has no known hazardous components or toxic intermediary compounds, is compatible with hydrogen peroxide, can be made isotonic with seawater and has an aquatic toxicity profile that is equal to or significantly better than formulations on the NCP list for surface water dispersants and surface washing agents and specifically the Corexit® formulations on the NCP.

Formulation-Type 3.

This formulation contains 2 to nonionic alkyl glycoside crosspolymer surfactants. Some formulations have only 2 nonionic alkyl glycoside crosspolymer surfactants.

In some embodiments, Formulation-Type 3 can contain a plant-based cosolvent such as a citrus terpene or various terpenoid compounds. In other embodiments, formulations contain no solvents or cosolvents other than water.

Formulation-Type 3 has been designed to create a reverse micelle system in which the oil emulsion phase floats with little aqueous emulsification of the oil. In this system, the single emulsion phase consists of the crude oil compounds outside of the micelle as the continuous phase and water is inside of the micelle associated with the hydrophilic head of the surfactant molecules. This is complementary to skimming, cleaning operations and other recovery, and ensures that the emulsified oil floats.

The surfactant components in this formulation are approved and used for cosmetics and various lotions. This surfactant mixture was developed based on its green synthesis manufacture, biodegradability, and ability to bring hydrocarbons into a water-in-oil microemulsion and to form a continuous floating oil-emulsion phase.

Formulation-type 3 keeps the dispersed oil floating, enables natural degradation processes to take place efficiently, works over a wide range of concentrations, emulsifies toxic aromatic compounds, is safe for workers to handle and come into contact with, does not result in any vapor phase materials associated with the dispersant, has no known hazardous components or toxic intermediary compounds, is compatible with hydrogen peroxide, can be made isotonic with seawater and has an aquatic toxicity profile that is far superior than formulations on the NCP list for surface water dispersants and surface washing agents and specifically the Corexit® formulations on the NCP.

Formulation-Type 4.

Formulation-type 4 may include any of Formulation-type 1, 2, or 3, plus hydrogen peroxide. The addition of hydrogen peroxide enables chemical oxidation to take place either by mineralizing dispersed crude oil constituents or by transforming crude oil constituents into more degradable compounds. Additionally, hydrogen peroxide enhances photooxidation reactions with UV wavelengths in the natural sunlight spectra, as well as greatly stimulating aerobic biodegradation of the dispersed crude oil; the result of the production of oxygen gas associated with the decomposition of peroxide. In water, it is well documented that peroxide can produce photo-Fenton reactions. Additionally, it is also well documented that micellularization of crude oil constituents, such as PAHs, leads to faster rates of aerobic microbial degradation and photodegradation. In open water, estuarine, and sediment environments where hypoxia already exists or is close to occurring in the Gulf of Mexico region, the addition of hydrogen peroxide can help offset hypoxia due to the significant increase in crude oil-related substrate (with our without added flux of crude oil substrate associated with the use of dispersants alone) entering these environments associated with the Deepwater Horizon release.

Formulation-Type 5.

Formulation-type 5 comprises a mixture of 1 to 3 ethoxylated plant oil or ethoxylated-amidated plant oil based surfactants with 1 to 3 alkyl glycoside crosspolymer surfactants. Some Formulation-types 5 are a mixture of, for example, 3 ethoxylated plant oil or ethoxylated-amidated plant oil with 1 non-ionic decylglucoside-based surfactant. In addition to surfactants, Formulation-type 5 also contains hydrogen peroxide or an organic peroxide. Formulation-type 5 also contains plant-based cosolvents such as a citrus terpene or various terpenoid compounds. Formulation-type 5 has been designed to penetrate hydrocarbon containing materials, form a nano-scale oil-in-water emulsion with the hydrocarbon, and to react with the emulsified hydrocarbon to accelerate degradation processes including one or more chemical oxidation, photooxidation, and biodegradation.

The surfactant systems described herein provide the basis for oil dispersant and surface washing agents. These formulations can be used for applications such as open water dispersion, collection, or cleaning of crude oil, hydrocarbon mixtures, and immiscible organic chemical with densities equal to or less than that of water, as well as surface washing or surface cleaning applications in aquatic and terrestrial environments, and man-made materials and structures. Formulation-types 1, 2, 3, 4 and 5 are examples of non ionic surfactant mixtures with differing composition resulting in a range of desired dispersant or surface washing and cleaning properties. Hydrogen peroxide or other peroxide species, such as organic peroxides, can additionally be added to the formulations during manufacture to result in acceleration of emulsification, dispersion, collection, or oil degradation processes, beyond that of the surfactant-emulsified oil alone. These surfactant systems were developed to have a range of performance characteristics and toxicity profiles.

### Methods of Use

Embodiments of the invention include methods for remediating a surface water oil spill by applying onto an oil-spill impacted surface water environment a biodegradable composition comprising at least one surfactant. The surfactant may include one or more ethoxylated plant oils, ethoxylated-amidated plant oils, or nonionic alkyl glycoside crosspolymers. The surfactant is applied in an amount sufficient to remediate the spilled oil.

The environment may be marine water, estuarine water, freshwater, or wetlands. The environment may also include shorelines, beaches, rocks, sand, boats, buoys, bridges, docks, and jetties.

In some embodiments, the composition is applied by spraying the composition onto the surface water environment. In some embodiments, the composition is isotonic with the surface water.

In some embodiments, the composition further includes an oxidant. The oxidant may be a persulfate, sodium persulfate, a percarbonate, a peroxide, hydrogen peroxide, ozone, oxygen, and combinations. In some embodiments, the oxidant is hydrogen peroxide.

The composition may further include a biodegradable cosolvent selected from the group consisting of a terpene, a citrus-derived terpene, limonene, d-limonene, and combinations of these.

In some embodiments, the surfactant includes at least one ethoxylated or ethoxylated-amidated plant oil. The surfactant may have two different ethoxylated or ethoxylated-amidated plant oils. The surfactant may have at least three different ethoxylated or ethoxylated-amidated plant oil. The ethoxylated or ethoxylated-amidated plant oil may be, for example, ethoxylated or ethoxylated-amidated forms of castor oil, coconut oil, corn oil, sesame oil, almond oil, cottonseed oil, olive oil, palm oil, peanut oil, safflower oil, soybean oil, or rapeseed oil. In some embodiments, the surfactant includes one or more of ethoxylated coconut oil, ethoxylated castor oil or ethoxylated-amidified coconut oil.

In some embodiments, the composition has at least one nonionic alkyl glycoside crosspolymer. The composition may have at least two different nonionic alkyl glycoside crosspolymers. The alkyl glycoside crosspolymer may be, for example, a decylglucoside crosspolymer, laurylglucoside crosspolymer, or n-tetradecylglucosides. In some embodiments, the alkyl glycoside crosspolymer is sorbitan oleate decylglucoside crosspolymer. Different alkyl glycoside crosspolymers may have different structures, different polymer components, or may have the same polymer components, but different hydrophile-lipophile balances. In some embodiments, the surfactant includes two sorbitan oleate decylglucoside crosspolymers with different hydrophile-lipophile balances.

In some embodiments, the surfactant has at least one ethoxylated or ethoxylated-amidated plant oil, and at least one nonionic alkyl glycoside crosspolymer. In some embodiments, the only surfactants in the composition are alkyl glycoside crosspolymers.

In some embodiments, the composition is essentially free of solvent. As used herein “solvent” does not include water.

In some embodiments, the surfactant includes one or more of ethoxylated coconut oil, ethoxylated castor oil or ethoxylated-amidified coconut oil. The surfactant may further include a sorbitan oleate decylglucoside crosspolymer. The composition may further include hydrogen peroxide.

These surfactant systems were developed for the various application scenarios encountered during an oil spill, when used for surface washing of structures, rocks, beaches, wetlands or hard surface cleaning. Where homogeneous emulsification in a continuous water phase is desirable (i.e., enhanced dissolution in oil-in-water micelles), Formulation-type 1 is the best choice. Where emulsification of the oil in a water-in-oil dispersion is desirable, with the dispersed oil phase floating on the surface of water, the Formulation-type 3 is the best choice. In systems where both a homogeneous emulsion of the crude oil and a separate floating water in oil emulsion is desirable, Formulation-type 2. In environments where dispersion of the crude oil and enhancement of the dispersed oil destruction is preferred the additional of hydrogen peroxide can have a profound impact on the fate and transport of the dispersed crude oil.

The inventive composition is intended to be added to surface water, but does not include the composition formed after addition to the surface water. The salinity of the composition may be adjusted to be isotonic with the water being treated. Thus, if saltwater is treated (i.e. due to an oil spill at sea), then a composition with a higher salt content may be used. Areas with lower salt concentration include estuaries and bays where fresh water mixes with salt-water. Freshwater sources include rivers and lakes. Matching the salinity of the water to be treated improves the dissolution of the surfactant into the water, reducing the amount of time necessary for the composition to disperse within the surface water.

The compositions may be introduced by means known to those of skill in the art. In many instances, the composition may be applied directly to an oil spill by spraying or dumping (i.e. from a boat or seagoing vessel), may be distributed by aircraft, with handheld sprayers, or vehicle based spraying equipment. A combination of approaches may be used to deliver different compositions or elements of the composition.

Individual components of the composition may be administered together or separately. For example, the surfactant and/or cosolvent may be introduced, followed by oxidant. In other embodiments, the surfactant and oxidant are introduced simultaneously from two different sources. In other embodiments, the surfactant and oxidant are present in a single composition. Generally, an activator is introduced separately, or may be introduced in a composition with the surfactant. In some embodiments, all the components are introduced simultaneously.

The components may be introduced in any order. In some embodiments, however, the surfactant composition is introduced first. The surfactant composition may partially or completely disperse the crude oil contaminant prior to addition of oxidant and/or activator. In embodiments where the surfactant and oxidant are introduced in a single composition, an activator may be added afterwards. In such embodiments, the crude oil contaminant may be partially or completely dispersed prior to addition of the activator.

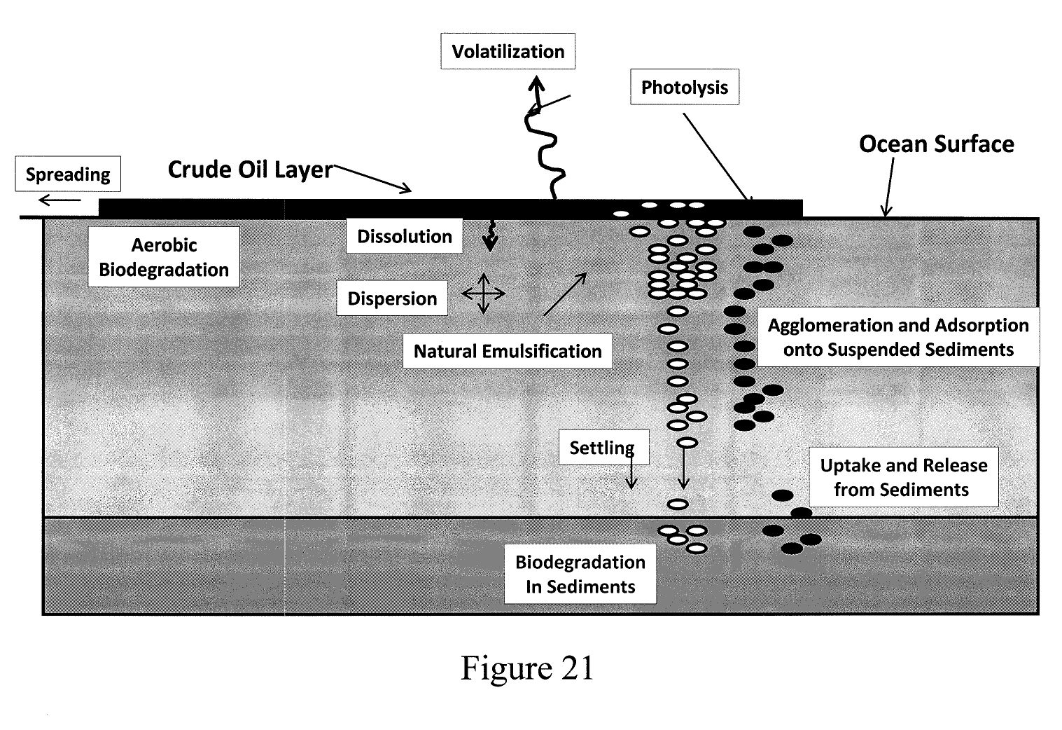

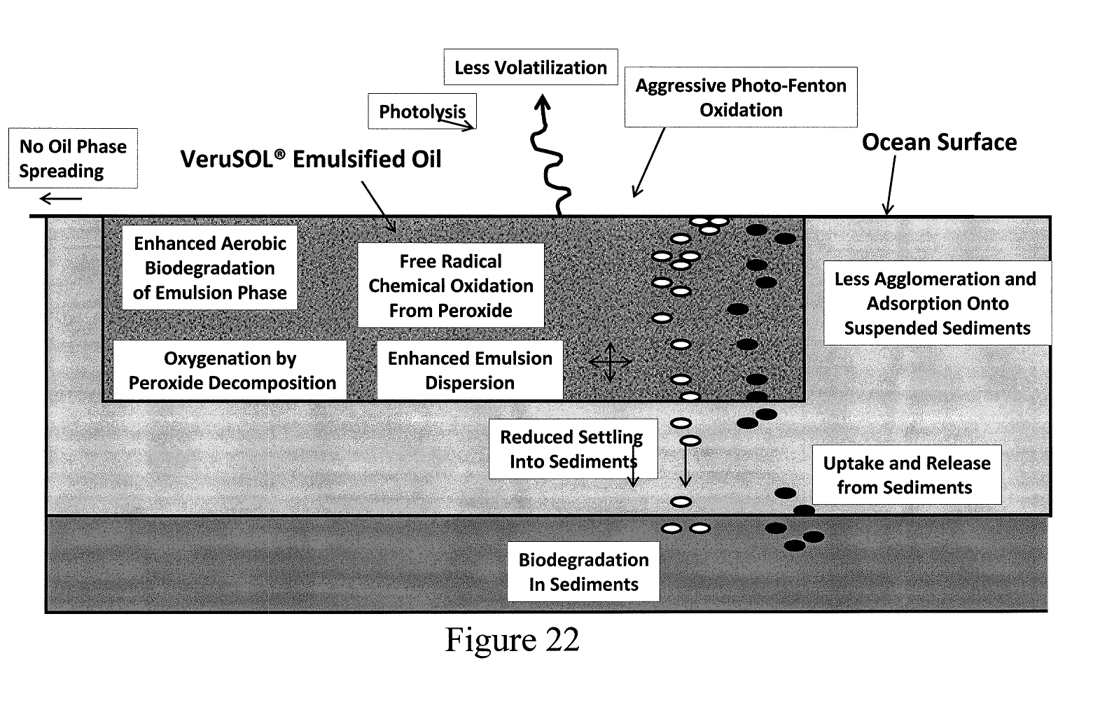

On water, a number of factors combine to increase the severity of an oil spill, and are depicted in FIG. 21. The surfactant composition increases the solubility and/or dispersibility of the crude oil contaminant. By removing the oil from the water surface (by dissolution), less volatilization occurs, and the oil spill does not spread as quickly on the surface. Hydrogen peroxide oxidation degrades emulsified crude oil, makes more biodegradable products, and generates dissolved oxygen. The emulsions are subject to photocatalytic reactions from sunlight and are also subject to natural biological reactions. Increased solubility and/or dispersibility increases the dissolution of the oil contaminant into the water, thereby increasing bioremediation or other natural processes to decompose the oil. These bioremediation processes may be enhanced by the use of naturally derived biodegradable surfactants and chemical oxidative degradation. These benefits are shown in FIG. 22.

In some embodiments, after treatment the environment is washed to remove adsorbed crude oil. In oil-spill impacted areas, crude oil adsorbs to the surface of rocks, sand, concrete, building materials and plants, usually as a sticky tar, which is difficult to remove. By treating the environment with the composition described herein the rocks, sand, and/or plants may then be washed with clean water to remove the adsorbed crude oil. Since the surfactants and cosolvents used are nontoxic, animals and plants may be treated without harmful effects. The washed-off oil may be collected, treated or disposed of separately.

In instances where a shoreline or waterfront area is threatened by an oil spill, the area may be pre-treated with the surfactant composition. Pretreatment prevents crude oil contaminants from adhering to the rocks, sand, concrete building materials and/or plants present in the waterfront area. The are may be more easily cleaned afterwards.

Furthermore, contaminated shoreline or waterfront areas treated with the surfactant compositions described herein are resistant to further contamination, and may be more easily cleaned afterwards.

In some embodiments, the crude oil is degraded, usually by oxidation. The oxidation may be chemical, biological, or biochemical in origin. In some embodiments, an oxidant is included in the composition, which oxidizes the crude oil contaminant. The oxidation process may completely decompose the crude oil contaminant to carbon dioxide and water, or may partially oxidize the crude oil contaminant to an oxidized form, which is more soluble in water, and more amenable to biodegradation. Furthermore, since the surfactants and or cosolvents used in the compositions are non-toxic and biodegradable, the compositions themselves encourage growth of organisms which biodegrade the crude oil contaminant. In some embodiments, microemulsions formed by the compositions described herein, oxidant degraded oil and enhanced oxygenation from peroxide greatly stimulates natural biodegradation processes leading to more rapid and complete degradation.

In some embodiments, an activator may be added with, or after addition of an oxidant. As discussed above, the activator activates the oxidant, producing free radicals and increasing the rate of oxidation of the crude oil contaminant. Alternative, an activator may be present inherently in the oil spill.

Any composition described herein may be applied directly on the oil, oil/water emulsion, or oil coated materials; and is effective for fresh or aged oil or oil combinations. The compositions described herein are aqueous based liquids without solids that can be readily applied through standard spray equipment. The compositions described herein are for treating oil on surface of open water, shoreline, sensitive environments, and for treating access limited areas and structures. Upon application, compositions described herein associate directly with the oil to form microemulsions so that the water, sand, marsh, or rock surface can be cleaned of the oil phase. As a consequence of the oil dispersion, acceleration of photooxidation and biodegradation processes may occur.

In some embodiments, compositions may be applied by direct spraying. Compositions may be applied to oil on shoreline or marsh surfaces by agricultural or standard sprayers attached to all terrain vehicles (ATVs), or workboats equipped with spray booms. The preferred and most effective method of application is to use a low-volume, low-pressure pump so the product can be applied undiluted (i.e. as a concentrate) or diluted (i.e. as a working strength solution) to the spilled oil. Compositions may be applied as droplets, not fogged or atomized. Natural wave, tide, or boat wake action usually provides adequate mixing energy to disperse the oil once treated.

In some embodiments, compositions may be applied by aerial spraying. Aircraft may provide the most rapid method of applying compositions described herein to an oil spill in large and open water or marsh areas and a variety of aircraft can be used for spraying. For aerial spraying, compositions may be applied undiluted (i.e. concentrate) or diluted (i.e. working strength solution). Typical application altitudes of 30 to 50 feet have been used, although higher altitudes may be effective under certain conditions. Actual effective altitudes will depend on the application equipment, weather and aircraft. Careful selection of spray nozzles may achieve desired dose levels, since droplet size must be controlled so that contact with the oil spill is in the form of a droplet and not a fog or atomized.

Spray systems may be calibrated. Spray systems may be calibrated to ensure accurate application rates for successful application and dosage control. Application may be limited at sub-freezing temperatures without the inclusion of antifreeze additives. Compositions described herein may be applied effectively at temperatures above freezing without notable changes in viscosity with increasing temperature. Neither application nor efficacy is effected by increasing salinity. Compositions described herein are effective at water temperatures above freezing (32° F., 0° C.), and highly effective at water temperatures above 70° F. (21° C.).

Concentration or Application Rate may be controlled. A treatment rate of about 100 to 350 U.S. gallons per acre, or a dispersant to oil ratio of 1:30 to 1:10 is recommended. This rate varies depending on the type of oil, degree of weathering, temperature, and thickness of the slick.

Compositions described herein will separate the oil and water from the sand or soiled surface. Cleaning of oil soaked items or objects should be done in a contained area and residue should be collected. For sand or vegetation cleaning, a berm may be constructed down slope that will collect the residue for disposal. Oil that has separated from sand or vegetation may be recovered from the substrate and collected for disposal and the water reused for additional washes.

From the foregoing description, it will be apparent that variations and modifications may be made to the invention described herein to adopt it to various usages and conditions. Such embodiments are also within the scope of the following claims.

The recitation of a listing of elements in any definition of a variable herein includes definitions of that variable as any single element or combination (or subcombination) of listed elements. The recitation of an embodiment herein includes that embodiment as any single embodiment or in combination with any other embodiments or portions thereof.

Where a range of values is provided in the present application, it is understood that each intervening value, to the tenth of the unit of the lower limit unless the context clearly dictates otherwise, between the upper and lower limit of that range and any other stated or intervening value in that stated range, is encompassed within the invention. The end values of any range are included in the range.

Terms listed in single tense also include multiple unless the context indicates otherwise.

The examples disclosed below are provided to illustrate the invention but not to limit its scope. Other variants of the invention will be readily apparent to one of ordinary skill in the art and are encompassed by the appended claims. All publications, databases, and patents cited herein are hereby incorporated by reference for all purposes.

### EXAMPLES

Each of the three formulations were separately analyzed for physical and chemical characteristics. Each formulation was also then tested over a wide range of concentrations that are reflective of those that would be used in the field. Finally, each formulation is also delivered as a product with various concentrations of peroxide added. As such, a discussion is included for each formulation with respect to its use as part of a dispersant-oxidant mixture.

### EXPERIMENTAL METHODS

Several methodologies were used to evaluate the performance of examples of Formulation-types 1, 2 and 3 in the micellularization of USEPA South Louisiana Reference Crude Oil purchased from Resource Technology Corporation, 2931 Soldier Springs Road, P.O. Box 1346, Laramie, Wyo. 82070, (307) 742-5452. Significant work was conducted to evaluate performance over a wide range of surfactant concentrations for each of the formulations, reflective of those that would be used during application in surface water, surface cleaning, beach and wetland treatment or hard surface cleaning. Performance evaluation also included concentrations and dispersant to oil ratios reflective of those single values specified in the Swirling Flask Dispersant Effectiveness Test methodology, although different reactors were used to generate the large sample volume needed to conduct VOC analysis using USEPA Method 8260C, SVOC analysis using USEPA Method 8270, and Total Petroleum Hydrocarbons Gasoline Range Organics (GRO) and Diesel Range Organics (DRO) using USEPA Method 8015. Micelle particle size analysis and zeta potential was conducted with a Malvern Zetasizer Nano ZS dynamic light scattering laser system. Crude oil analyses in water were also conducted with a SiteLAB Fluorometer, using hexane extraction and calibrated with the USEPA South Louisiana Reference Crude Oil. This fluorometry method does not detect components of any of the surfactant components, such as with UV/VIS spectroscopy, as used in the NCP Swirling Flask Dispersant Effectiveness Test. Heavy metal analysis of the surfactants was conducted using USEPA Method 6010C, and mercury analysis by USEPA Method 7471B. Surfactants were additionally analyzed for VOCs by USEPA Method 8260C, PCBs using USEPA Method 8082A, and pesticides using USEPA Method 8081B. Interfacial tension (IFT) measurements were conducted using a SITA Dynotester/bubble tensiometer.

Physical and Chemical characterization of the three example formulations were conducted and generally followed the NCP requirements. Where the NCP specified methodologies have been replaced by USEPA with more modern methods, the updated methods were used. For example, where the NCP lists the use EPA Method 601—Purgeable halocarbons (Standard Method 6230B) using a halide specific detector, in the work EPA Method 8260C was used with GC/MS analysis and also includes non-chlorinated VOCs for a more complete analysis of VOCs with better qualitation using MS detection.

The Swirling Flask Dispersant Effectiveness Test is limited to a single concentration of dispersant and crude oil at a fixed dispersant to crude oil ratio with a limited analysis of the crude oil by UV/VIS spectroscopy. Consequently, this type of analysis provides no information regarding physiochemical characteristics of the dispersant in seawater, as well as limited useful information regarding performance of the very wide range of concentrations that the dispersant is actually diluted to during application. To gain an understanding of the physciochemical and performance characteristics of dispersant-crude oil (or any immiscible organic phase) very different experimental procedures, systems and analyses are necessary. This work describes those methods and associated results of using this new methodology.

IFT-surfactant concentration, micelle particle size-surfactant concentration relationships and CMC calculations were made by measuring IFT at a series of surfactant concentrations in artificial seawater made with Instant Ocean®. Measurements were made with the following surfactant concentrations: 0 mg/L, 350 mg/L, 500 mg/L, 1,000 mg/L, 2,500 mg/L, 5,000 mg/L, 10,000 mg/L, 25,000 mg/L and 50,000 mg/L. Surfactant concentrations were made in individual 60 mL glass vials.

Crude oil effectiveness tests were conducted in 500 mL glass flasks with Teflon® lined screw on caps, containing the same surfactant concentrations as listed with the IFT tests above. The order of addition of reagents in the flasks was dry chemical Instant Ocean® to obtain final concentration of 34.6 g/L, a weighed amount concentrated surfactant mixture to result in the desired final total surfactant concentration, water, then 5 g of the crude oil. This method of oil addition is similar to the drop method used by others⁵ to more accurately simulate application of surfactants in field applications. Each reactor was placed on an orbital shaker table operating at 150 rpm for 72 hours and then settled for 1 hour. At least 24 hours of mixing may be required for equilibrium to be reached in these oil-water-surfactant systems. Therefore, 72 hours is conservative to assume equilibrium is reached. Clearly, contact times are much longer duration during actual application. The mixing period of 20 minutes, specified in the NCP Swirling Flask Dispersant Effectiveness Test, is arbitrary and is not reflective of equilibrium conditions and is subject to significant error, the result of incomplete mixing. Settling for a one-hour period is conservative in comparison to the 10 minute period specified in the NCP. The reactors were run at 22° C. After the 72 hour shaking period and immediately prior to the one-hour settling period, the fixed cap on each reactor was removed and replaced by a cap penetrated with a Swagelok® fitting containing a Teflon tube extending above the top of the liquid layer allowing air to enter when draining but minimizing VOC losses from the emulsion phase. An additional barbed fitting with Tygon® tubing attached was also bolted onto the cap and used to penetrate the cap and allow the bottom liquid in the reactor vessels to drain, without removing any oil that may have been floating on the top of the liquid in the reactor. Immediately, after the new cap was placed on the reactor, each tube was clamped and the reactor was inverted to allow any oil to float to the top of liquid in reactor. After the 1 hour settling period, the drain tube and the vent tube (the top of the Teflon® vent tube was above the oil layer) were carefully opened and the dispersed oil phase was allowed to drain. Aliquots of samples were placed in prepared sampling containers received from the NELAC certified third-party analytical laboratory for VOC, SVOC and TPH (GRO), and TPH (DRO) analyses. Additional samples were then placed into sampling containers for specific analyses conducted at VeruTEK®, including, particle size, zeta potential, pH, turbidity and IFT. Any oil present above the liquid phase in the reactors was then placed into separate sampling containers for future analysis.

### Example 1

### Formulation-Type 1—VeruSOL®-Marine

VeruSOL®-Marine is manufactured by VeruTEK® Technologies, Inc., 65 West Dudley Town Road, Bloomfield, Conn., USA (860) 242-9800. VeruSOL®-Marine contains no chlorinated or non-chlorinated solvents and contains no alcohols. The maximum and minimum storage temperatures are 43° C. and 5° C. The optimum temperature range of this product is 10° C. to 40° C. There is no known temperature within the maximum and minimum storage temperature that would cause phase separation, chemical changes or other known alternations to the effectiveness of the product. This product has no known limitations to shelf life and will not degrade over time. The composition of VeruSOL®-Marine is three nonionic ethoxylated surfactants: Ethoxylated Castor Oil, CAS No. 61791-12-6; Ethoxylated Coconut Fatty Acid, CAS No. 61791-29-5; and Ethoxylated Coconut Amide CAS No. 61791-08 with each component in the 5%-40% concentration range in a concentrate.

### Physiochemical Performance Results

Pure VeruSOL®-Marine was analyzed for VOCs, Pesticides, PCBs and heavy metals by a third party NELAC Certified Laboratory. All VOCs were below reporting limits of 780 ppm. Concentrations reported for all PCBs analyzed using EPA Method 8082A were below reporting limits of 990 μg/kg. Pesticides concentrations analyzed using EPA Method 8081B were all reported below reporting limits varying from 51 μg/kg to 99 μg/kg. Metals analysis for arsenic was below reporting limits of 0.73 mg/kg, cadmium was below reporting limits of 0.18 mg/kg, copper was below reporting limits of 1.1 mg/kg, nickel was below reporting limits of 1.8 mg/kg, chromium was detected at 0.044 mg/kg, lead was detected at 0.11 mg/kg, zinc was detected at 0.56 mg/kg, mercury was below reporting limits of 0.037 mg/kg, and total cyanide was less than 4.5 mg/kg. VOC, PCB, Pesticide, and heavy metal analyses were conducted by Mitkem Laboratories of Warwick, R.I. The Flash point of VeruSOL®-Marine is greater than 201° F., the Pour Point is at 42° F. the Specific Gravity is 1.0224 at 60° F., the Viscosity KinematicCST at 40° C. is 78.9, and pH was 7.5. All physical characteristics were measured by Mt.Tom Generating Co.LLC Analytical Laboratory of Agawam, Mass.

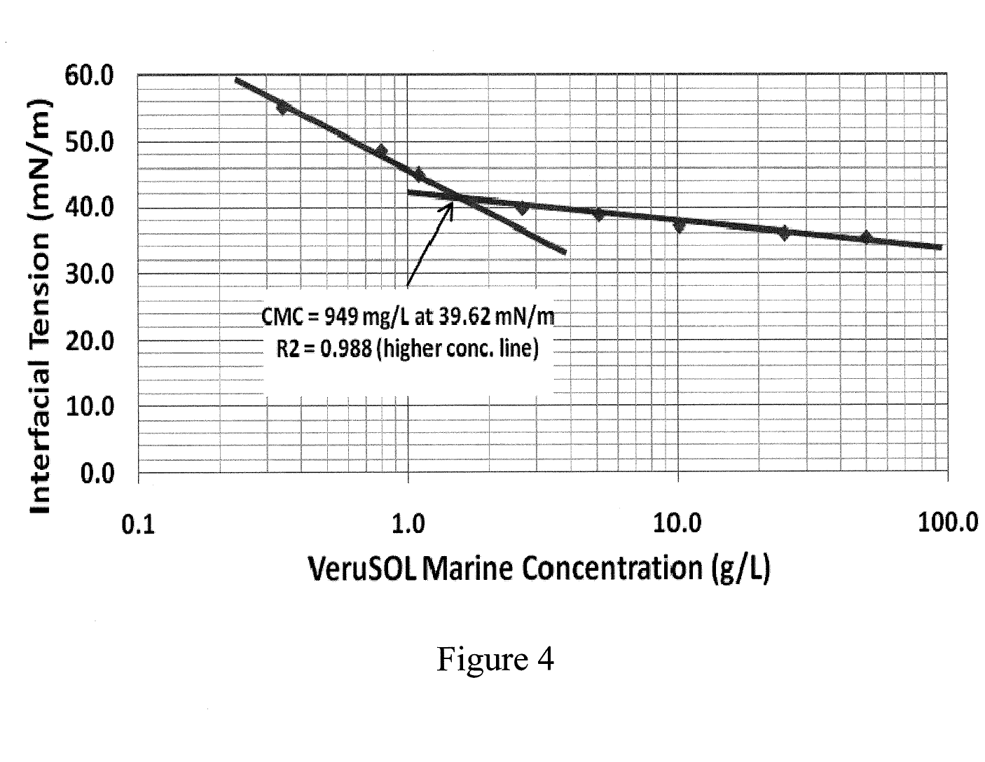

Physical characterization was conducted with varying concentrations of VeruSOL®-Marine to measure IFT and micelle particle size, in a surfactant-water alone mixture. Results plotted in FIG. 4 on a log-normal plot indicate a Critical Micelle Concentration (CMC) of 949 mg/L at an IFT of 39.62 mN/m. As expected, the CMC concentration and interfacial tension is greater than that of Corexit® 9527 of 382.9 mg/L, and 23 mN/m.

Various concentrations of VeruSOL®-Marine were used in the VeruTEK®-modified shaker flask method with 5 g of USEPA Reference South Louisiana crude oil and approximately 500 mL seawater. Therefore, the maximum concentration of crude oil that could be dispersed is 10 g/L. This maximum concentration is much greater than the maximum concentration that could potentially dissolve in the NCP Swirling Flask Dispersant Effectiveness Test is 636.4 mg/L, which is unrealistically low for an actual oil spill.

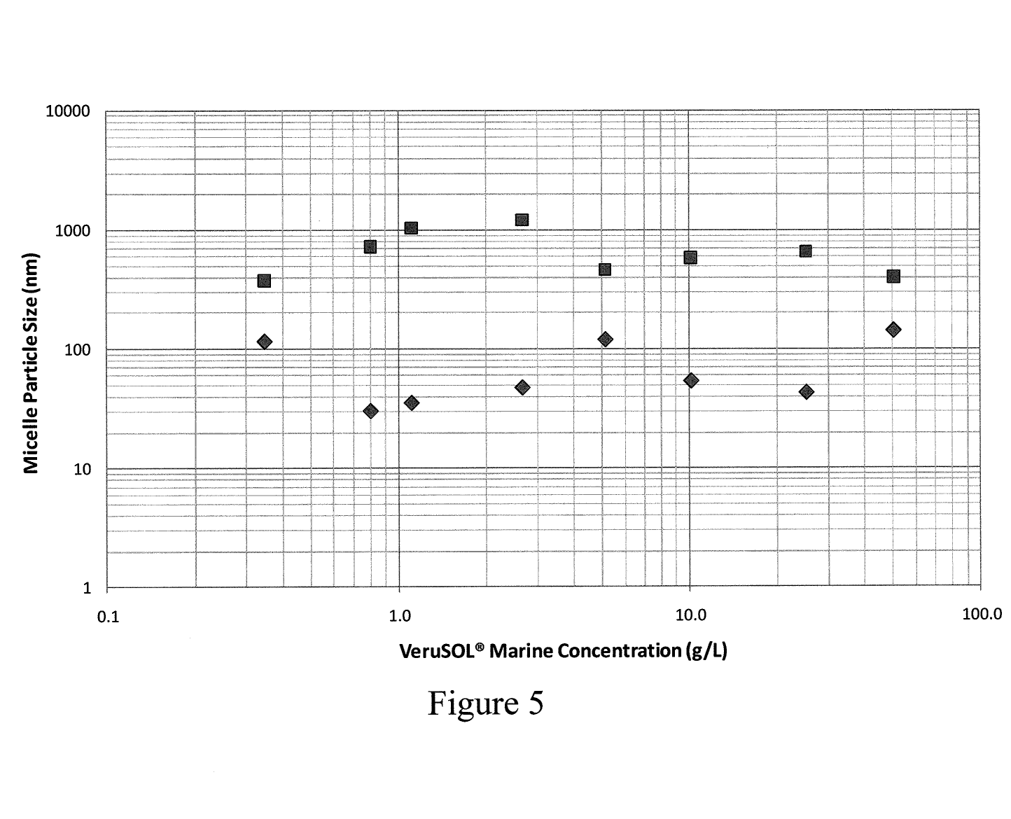

Particle size analysis of the crude oil-VeruSOL®-Marine emulsion is shown in FIG. 5 and is compared to the particle size analyses of VeruSOL®-Marine alone in seawater. Briefly, VeruSOL® Marine, water with 34.6 g/L Instant Ocean, and 5 g of Crude Oil were added to a series of 500 mL flasks and capped. Reactors were shaken for 72 hours at 120 rpm. Reactors were fitted with a draining cap (sealed) and were left to settle upside down for 1 hour. The emulsion phase was drained from the bottom and sampled, keeping any settled oil phase in the jar. Particle size analysis was conducted with the Malvern Zetasizer Nano ZS dynamic light scattering laser. It is evident that the particle size alone in seawater results in much smaller micelle structures than with the crude oil-VeruSOL®-Marine mixtures. Typically in fresh water systems particle size decreases with increasing concentration of the range tested for surfactant alone and surfactant-oil mixtures. It is interesting to note that particle sizes in the crude oil-VeruSOL®-Marine emulsions increase in size to ˜1,000 nm with surfactant concentrations equal to 2.5 g/L, then decrease in size after surfactant concentrations decrease. It is also interesting to note that the maximum particle size occurs near the CMC concentration in the crude oil-VeruSOL®-Marine system. Zeta potential measurements, not all reported here, were typically in the −2 to ˜4 mV range indicating relatively unstable suspensions. Suspensions were observed to rise during settling, revealing a suspension that would not sink.

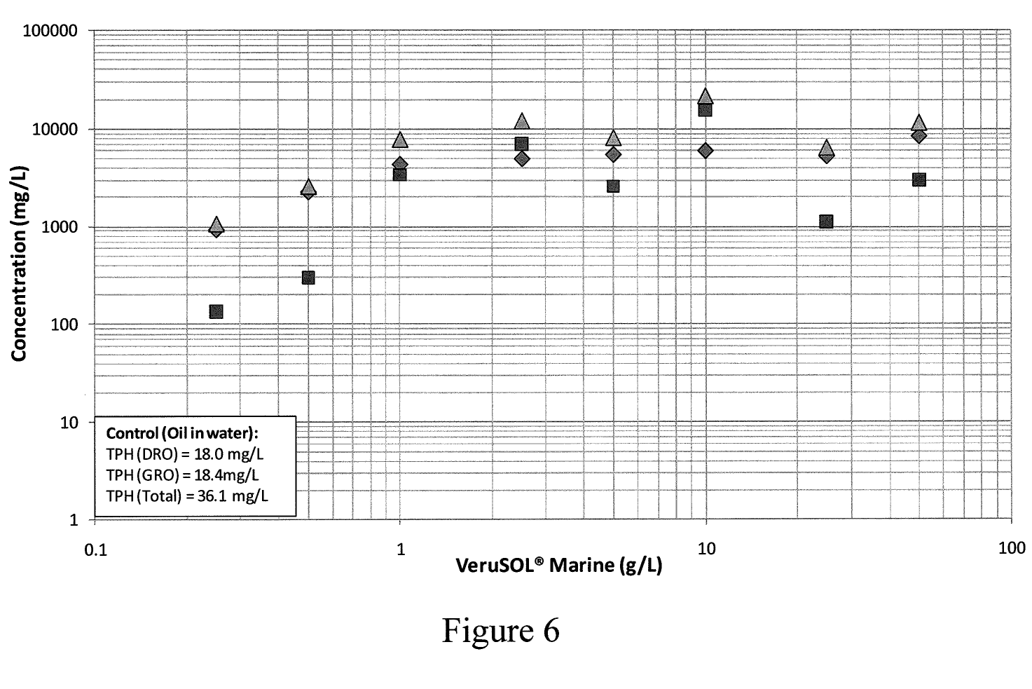

Performance of VeruSOL®-Marine to disperse crude oil was measured using VOCs, SVOCs and TPH (GRO) and TPH (DRO). Results of TPH (GRO), TPH (DRO) and Total TPH (measured as the GRO+DRO total) are presented in FIG. 6. Briefly, 1) VeruSOL® Marine, water with 34.6 g/L Instant Ocean, and 5 g of Crude Oil were added to a series of 500 mL flasks and capped. Reactors were shaken for 72 hours at 120 rpm. Reactors were fitted with a draining cap (sealed) and were left to settle upside down for 1 hour. The emulsion phase was drained from the bottom and sampled, keeping any settled oil phase in the jar. The emulsion phase was sent to a third party NELAC approved analytical laboratory for analysis: TPH Method 8015.

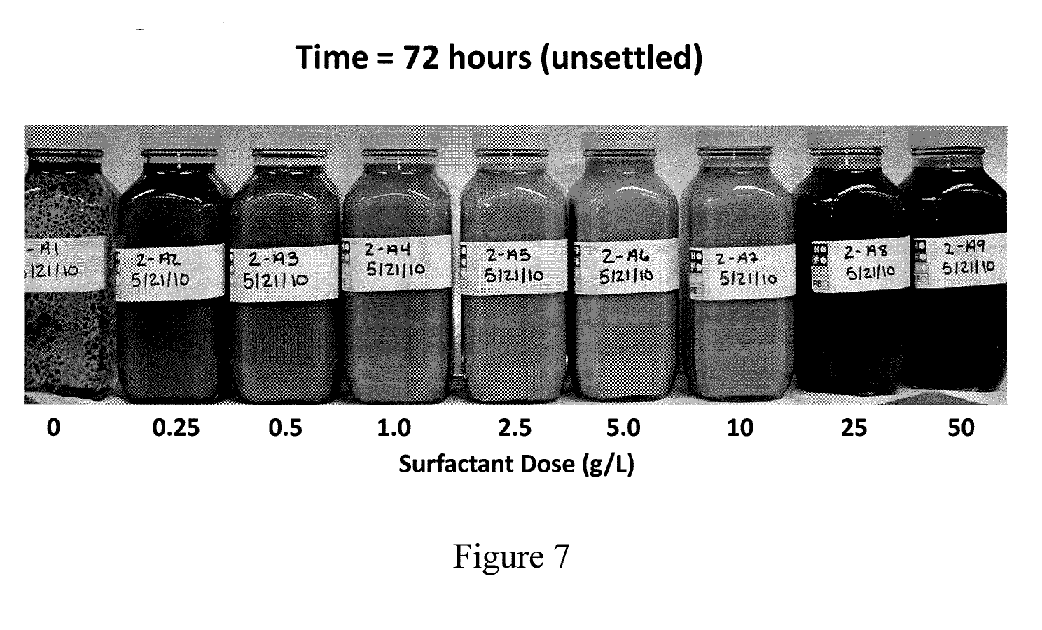

It can be seen that maximum emulsification of the crude oil, as measure by TPH was 21.4 g/L which is greater than the total maximum possible to be emulsified at a concentration of 10 g/L. Examination of the GRO concentration of 15.4 g/L at 10 g/L appears to be an outlier compared to the GRO concentrations emulsified at 5 g/L and 25 g/L. Total TPH concentration dissolved in the crude oil plus seawater alone was 0.036 g/L (0.018 g/L GRO and 0.018 g/L DRO). A control with VeruSOL®-Marine alone with no crude oil at a concentration of 50 g/L had a TPH of 0.214 g/L (0.020 g/L GRO and 0.194 g/L DRO). At the 0.5 g/L VeruSOL®-Marine dose, the crude oil emulsified at a TPH of 2.60 g/L (0.020 g/L GRO and 2.59 g/L DRO). The 0.5 g/L dose is below the CMC for this surfactant, but is at the 1:10 dispersant to crude oil ratio. At the 1.0 g/L VeruSOL®-Marine dose, the crude oil emulsified at a TPH of 7.81 g/L (3.40 g/L GRO and 4.41 g/L DRO). The 1.0 g/L dose is just at the CMC for this surfactant and is at the 1:5 dispersant to crude oil ratio. It can be concluded that at the CMC concentration VeruSOL®-Marine will emulsify 78% of the crude oil under these experimental conditions. In general, once the CMC surfactant concentration was reached nearly complete emulsification was observed. A photograph of this series of experiments following the 72 hour mixing period is shown in FIG. 7.

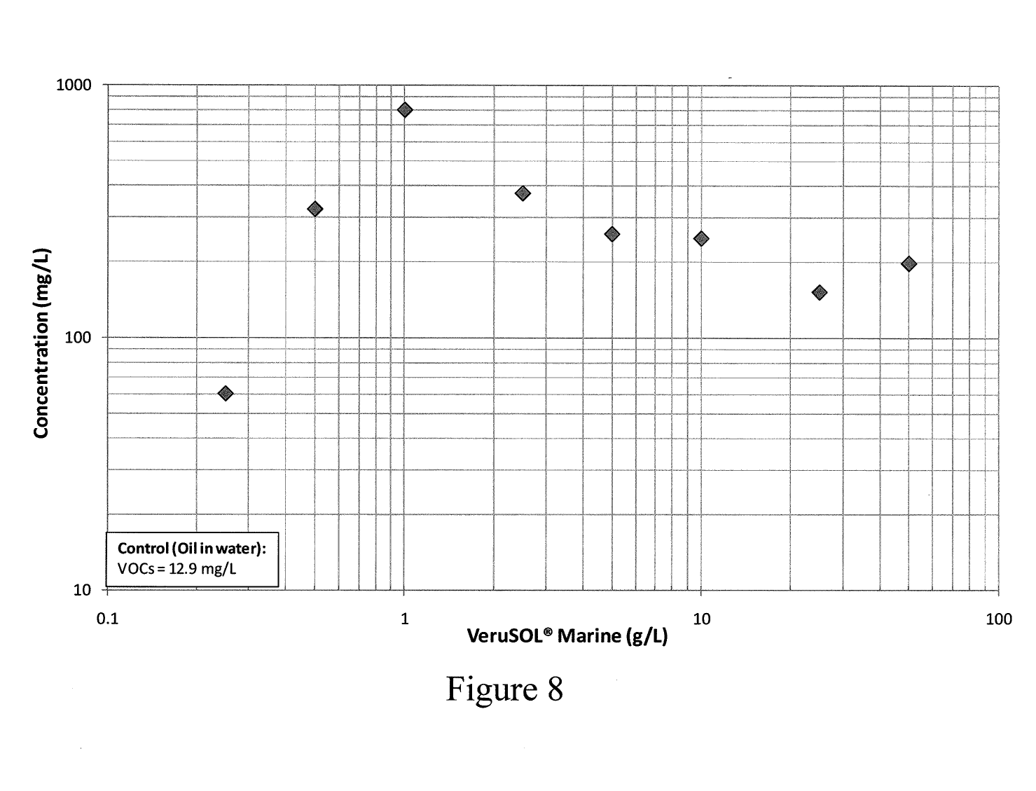

Results of analysis for total aromatic hydrocarbon VOC concentrations from the VeruSOL®-Marine performance tests are found in FIG. 8. Briefly, VeruSOL® Marine, water with 34.6 g/L Instant Ocean, and 5 g of Crude Oil were added to a series of 500 mL flasks and capped. Reactors were shaken for 24 hours at 120 rpm. Reactors were fitted with a draining cap (sealed) and were left to settle upside down for 1 hour. The emulsion phase was drained from the bottom and sampled, keeping any settled oil phase in the jar. The emulsion phase was sent to a third party NELAC approved analytical laboratory for analysis: VOC Method 8260.

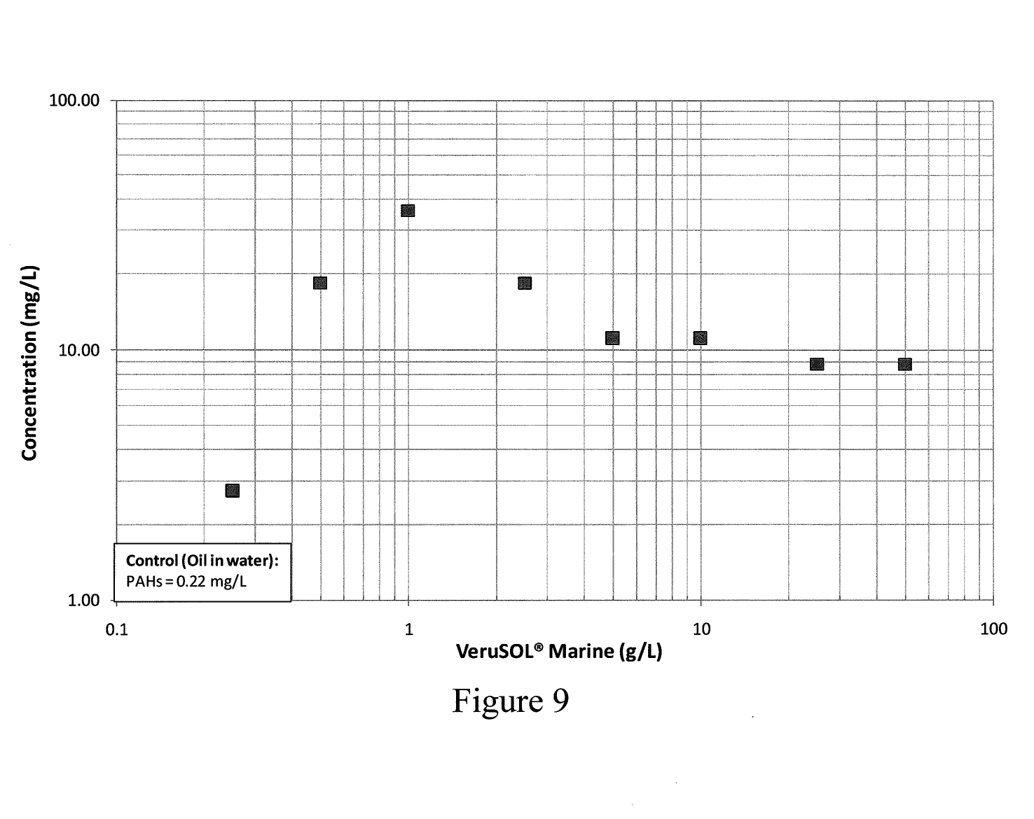

The trend in this aromatic VOC-surfactant concentration relationship is evident with a maximum concentration emulsified concentration of 0.802 g/L at the CMC. A similar trend was observed with total BTEX concentrations, however the maximum concentration was observed at the 2.5 g/L surfactant concentration. The total emulsified PAH concentrations for the VeruSOL®-Marine emulsion tests are found in FIG. 9. Briefly, VeruSOL® Marine, water with 34.6 g/L Instant Ocean, and 5 g of Crude Oil were added to a series of 500 mL flasks and capped. Reactors were shaken for 72 hours at 120 rpm. Reactors were fitted with a draining cap (sealed) and were left to settle upside down for 1 hour. The emulsion phase was drained from the bottom and sampled, keeping any settled oil phase in the jar. The emulsion phase was sent to a third party NELAC approved analytical laboratory for analysis. Note: Naphthalene included in total was detected using Method 8260, while all other PAHs were detected by Method 8270.

Again, a similar trend was observed with the maximum emulsified concentration of Total PAHs of 0.036 g/L occurring at the CMC, representing only a small fraction of the crude oil.

### Toxicity Testing

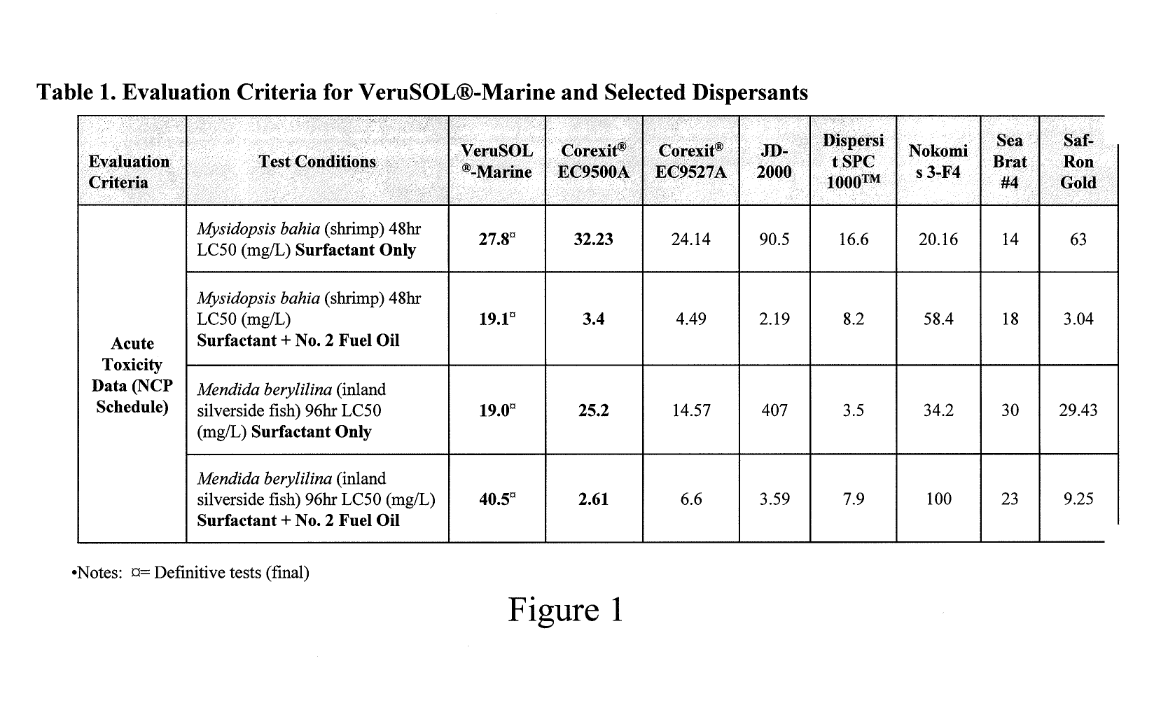

Toxicity test on VeruSOL®-Marine was conducted as specified in Appendix C, Section 3.0 of the NCP, by PBS&J, 888 West Sam Houston Parkway, South, Suite 110, Houston, Tex. 77042-1917. Aquatic toxicity test results for VeruSOL®-Marine are found in Table 1 (FIG. 1). The 48 hr LC₅₀ aquatic toxicity concentration for Mysidopsis bahia was 27.8 mg/L for VeruSOL®-Marine. This value falls between those for Corexit® EC9500A at 32.23 mg/L and for Corexit® EC9527A at 24.14 mg/L. Additional surfactants that are the least toxic on the NCP, as identified by British Petroleum in a recent communication to USEPA, are also identified in Table 1. When VeruSOL®-Marine was added to No. 2 Fuel Oil, as specified in the NCP aquatic toxicity procedures, the 48 hr LC₅₀ aquatic toxicity for Mysidopsis bahia was 19.1 mg/L. This concentration is considerably greater (i.e., lower toxicity) than either Corexit® surfactants on the NCP. There is only one dispersant on the NCP that has a lower toxicity than VeruSOL®-Marine for a mixture of dispersant and fuel oil. The 96 hr LC₅₀ aquatic toxicity concentration for Mendida berylilina is 19.0 mg/L for VeruSOL®-Marine. This value falls between those for Corexit® EC9500A at 25.2 mg/L and for Corexit® EC9527A at 14.57 mg/L. When mixed with No. 2 Fuel oil, the 96 hr LC50 toxicity concentration for Mendida berylilina was 40.5 mg/L. This is a much higher concentration (indicating lower toxicity) in comparison to reported values for Corexit® EC9500A at 2.61 mg/L and for Corexit® EC9527A at 6.6 mg/L. It is apparent that when VeruSOL®-Marine is mixed with No. 2 Fuel Oil, as specified in the NCP the aquatic toxicity is lower in comparison with most other dispersants.

Up to 7.81 g/L of crude oil (as TPH) was emulsified using very low concentrations of VeruSOL®-Marine, for example at 1.0 g/L. At this dose the oil emulsified to dispersant is 7.81:1. At the 0.5 g/L VeruSOL®-Marine concentration, with 2.61 g/L TPH emulsified, the oil emulsified to dispersant is 5.2:1. VeruSOL®-Marine results in a relatively unstable emulsion with crude oil, as indicated by zeta potential measurements with particle sizes in the 300 nm to 1,000 nm size range, with the emulsion observed to float to the surface during settling. The 48 hr LC50 aquatic toxicity concentration for Mysidopsis bahia was 27.8 mg/L for VeruSOL®-Marine. This value falls between those for Corexit® EC9500A at 32.23 mg/L and for Corexit® EC9527A at 24.14 mg/L. When VeruSOL®-Marine was added to No. 2 Fuel Oil, as specified in the NCP aquatic toxicity procedures, the 48 hr LC50 aquatic toxicity for Mysidopsis bahia was 19.1 mg/L. This concentration is considerably greater (i.e., lower toxicity) than either Corexit® surfactants on the NCP. The 96 hr LC50 aquatic toxicity concentration for Mendida berylilina was 19.0 mg/L for VeruSOL®-Marine. This value falls between those for Corexit® EC9500A at 25.2 mg/L and for Corexit® EC9527A at 14.57 mg/L. When mixed with No. 2 Fuel oil, the 96 hr LC50 toxicity concentration for Mendida berylilina was 40.5 mg/L. This is a much higher concentration (indicating lower toxicity) in comparison to reported values for Corexit® EC9500A at 2.61 mg/L and for Corexit® EC9527A at 6.6 mg/L.

### Summary

VeruSOL®-Marine is a formulation that contains no solvents, petroleum products or alcohols in its formulation. It is made of three non-ionic plant oil-based surfactants and is made isotonic with the marine environment, as needed. Performance results for VeruSOL®-Marine indicate excellent emulsification of the USEPA Reference South Louisiana crude oil. Up to 7.81 g/L of crude oil (as TPH) was emulsified using very low concentrations of VeruSOL®-Marine, for example at 1.0 g/L. At this dose the oil emulsified to dispersant is 7.81:1. At the 0.5 g/L VeruSOL®-Marine concentration, with 2.61 g/L TPH emulsified, the oil emulsified to dispersant is 5.2:1. VeruSOL®-Marine results in a relatively unstable emulsion with crude oil, as indicated by zeta potential measurements with particle sizes in the 300 nm to 1,000 nm size range, with the emulsion observed to float to the surface during settling. The 48 hr LC50 aquatic toxicity concentration for Mysidopsis bahia was 27.8 mg/L for VeruSOL®-Marine. This value falls between those for Corexit® EC9500A at 32.23 mg/L and for Corexit® EC9527A at 24.14 mg/L. When VeruSOL®-Marine was added to No. 2 Fuel Oil, as specified in the NCP aquatic toxicity procedures, the 48 hr LC50 aquatic toxicity for Mysidopsis bahia was 19.1 mg/L. This concentration is considerably greater (i.e., lower toxicity) than either Corexit® surfactants on the NCP. The 96 hr LC50 aquatic toxicity concentration for Mendida berylilina was 19.0 mg/L for VeruSOL®-Marine. This value falls between those for Corexit® EC9500A at 25.2 mg/L and for Corexit® EC9527A at 14.57 mg/L. When mixed with No. 2 Fuel oil, the 96 hr LC50 toxicity concentration for Mendida berylilina was 40.5 mg/L. This is a much higher concentration (indicating lower toxicity) in comparison to reported values for Corexit® EC9500A at 2.61 mg/L and for Corexit® EC9527A at 6.6 mg/L.

### Example 2

### Formulation-Type 2, VeruSOL®-Marine 200

VeruSOL®-Marine 200 is manufactured by VeruTEK® Technologies, Inc., 65 West Dudley Town Road, Bloomfield, Conn., USA (860) 242-9800. VeruSOL®-Marine 200 contains no chlorinated or non-chlorinated solvents (other than water) and contains no alcohols. The maximum and minimum storage temperatures are 43° C. and 5° C. The optimum temperature range of this product is 10° C. to 40° C. There is no known temperature within the maximum and minimum storage temperature that would cause phase separation, chemical changes or other known alternations to the effectiveness of the product. This product has no known limitations to shelf life and will not degrade over time. The composition of VeruSOL®-Marine is mixture of a single nonionic ethoxylated surfactant, Ethoxylated Coconut Fatty Acid, CAS No. 61791-29-5; and a decylglucoside surfactant (Poly Suga Mulse D3), recently developed (CAS Registry and TSCA Chemical Substances Inventory pending) with each component in the 25%-65% concentration range in a concentrate.

### Physiochemical Performance Results

Pure VeruSOL®-Marine 200 was analyzed for VOCs, Pesticides, PCBs and heavy metals by a third party NELAC Certified Laboratory. All VOCs were below reporting limits of 480 ppm. Concentrations reported for all PCBs analyzed using EPA Method 8082A were below reporting limits of 990 μg/kg. Pesticides concentrations analyzed using EPA Method 8081B were all reported below reporting limits varying from 51 μg/kg to 99 μg/kg. Metals analysis for arsenic was below reporting limits of 0.94 mg/kg, cadmium was below reporting limits of 0.24 mg/kg, lead was below reporting limits of 0.47 mg/kg, nickel was detected at 0.11 mg/kg, chromium was detected at 0.067 mg/kg, copper was detected at 0.42 mg/kg, zinc was detected at 0.66 mg/kg, and mercury was below reporting limits of 0.035 mg/kg, total cyanide was less than 0.97 mg/kg All Heavy Metals, PCB, Pesticide and VOC analyses were conducted by Mitkem Laboratories of Warwick, R.I. The Flash point of VeruSOL®-Marine 200 is greater than 201° F., Pour Point is 38° F., Specific Gravity is 1.0715 at 60° F., the Viscosity KinematicCST at 40° F. was 98.6 and pH was 7.4. All physical characteristics were measured by Mt.Tom Generating Co.LLC Analytical Laboratory of Agawam, Mass.

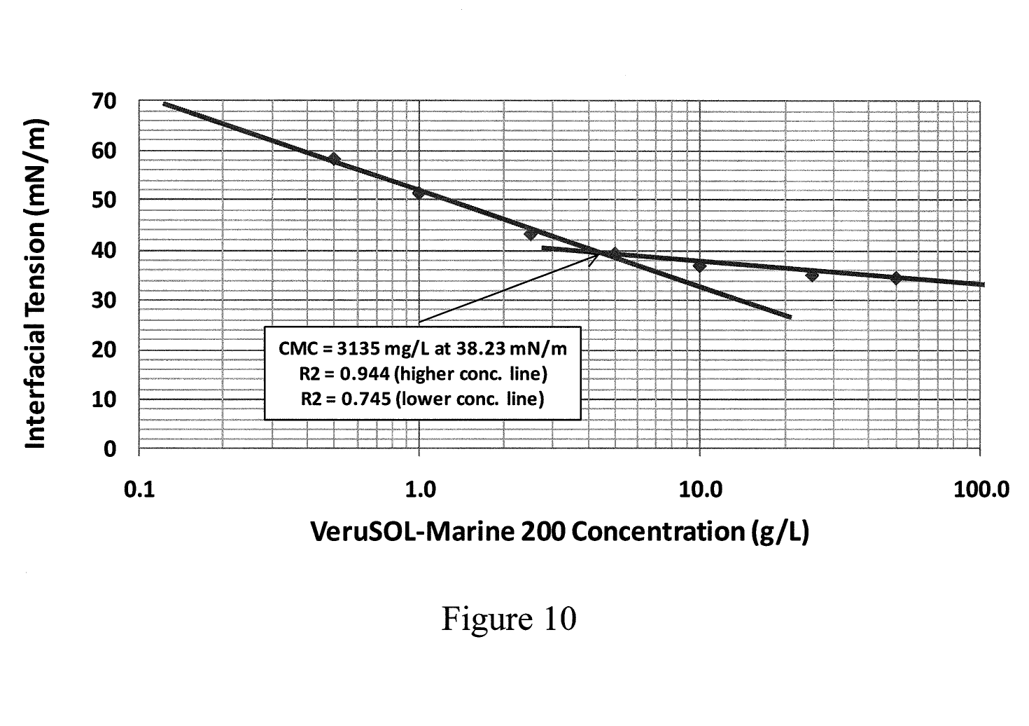

Physical characterization was conducted with varying concentrations of VeruSOL®-Marine 200 to measure IFT and micelle particle size, in a surfactant-water alone mixture. Briefly, Tests conducted at various surfactant concentrations with 34.6 g/L Instant Ocean. Critical Micelle Concentration (CMC) calculated by intersection of two linear regression lines of best fit. Results were plotted in FIG. 10 on a log-normal plot indicate a Critical Micelle Concentration (CMC) of 3,135 mg/L at an IFT of 38.23 mN/m. The CMC for VeruSOL®-Marine 200 is nearly a factor of 3 greater than that measured with VeruSOL®-Marine. As expected the CMC concentration and interfacial tension are greater than that of Corexit® 9527 of 382.9 mg/L, and 23 mN/m.

Various concentrations of VeruSOL®-Marine 200 were used in the modified shaker flask method with 5 g of USEPA Reference South Louisiana crude oil and approximately 500 mL seawater. Therefore, the maximum concentration of crude oil that could be dispersed is 10 g/L. This maximum concentration is much greater than the maximum concentration that could potentially dissolve in the NCP Swirling Flask Dispersant Effectiveness Test (636.4 mg/L), which is unrealistically low for an actual oil spill.

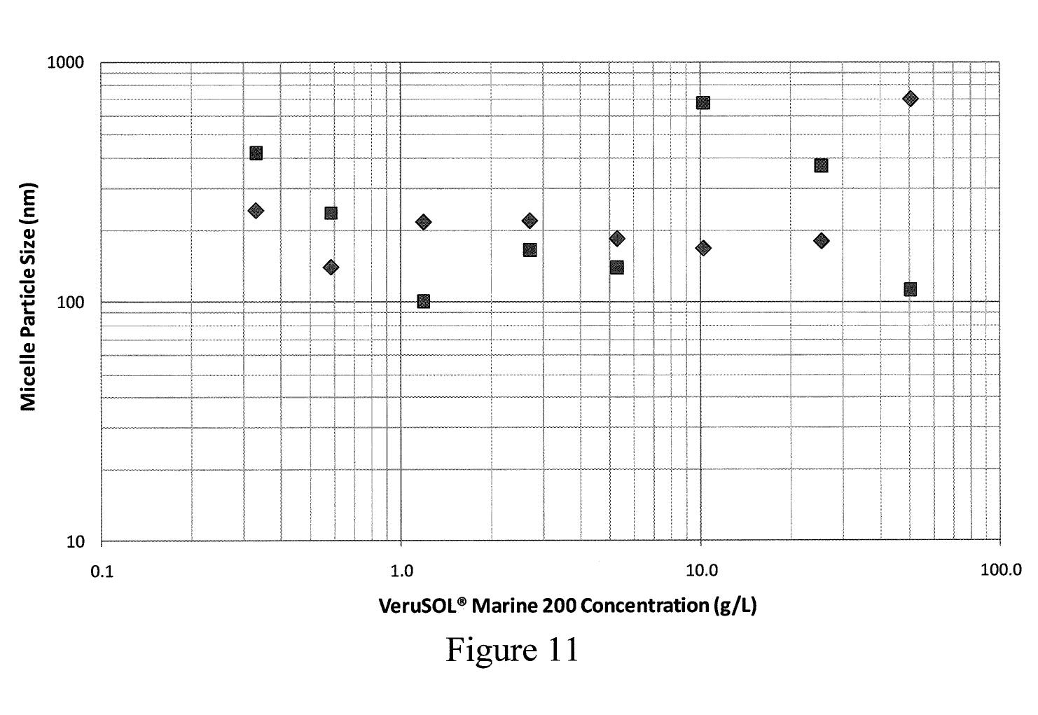

Particle size analysis of the crude oil—VeruSOL®-Marine 200 emulsion is shown in FIG. 11 and is compared to the particle size analyses of VeruSOL®-Marine 200 alone in seawater. Briefly, VeruSOL® Marine 200, water with 34.6 g/L Instant Ocean, and 5 g of Crude Oil were added to a series of 500 mL flasks and capped. Reactors were shaken for 72 hours at 120 rpm. Reactors were fitted with a draining cap (sealed) and were left to settle upside down for 1 hour. The emulsion phase was drained from the bottom and sampled, keeping any settled oil phase in the jar. Particle size analysis was conducted with the Malvern Zetasizer Nano ZS dynamic light scattering laser.

It is evident that the particle size of VeruSOL®-Marine 200 alone in seawater is in the similar size range of 100 nm to 700 nm as is the crude oil-VeruSOL®-Marine 200 mixtures. Samples generated for the crude oil-VeruSOL®-Marine 200 mixtures were mixed for 72 hours followed by a one-hour settling period. In general, micelle particle sizes for VeruSOL®-Marine 200 are smaller than observed with VeruSOL®-Marine. Zeta potential measurements, not all reported here, were typically in the −2 to −4 mV range in the crude oil-VeruSOL®-Marine 200 mixtures indicating relatively unstable suspensions. Suspensions were observed to rise during settling, revealing a suspension that would not sink. Interestingly, the zeta potential of a 50 g/L VeruSOL®-Marine 200 solution alone was −41.6 mV, indicating that the addition of crude oil destabilizes the VeruSOL®-Marine 200 emulsion, leading to floating of the crude oil—VeruSOL®-Marine 200 emulsion.

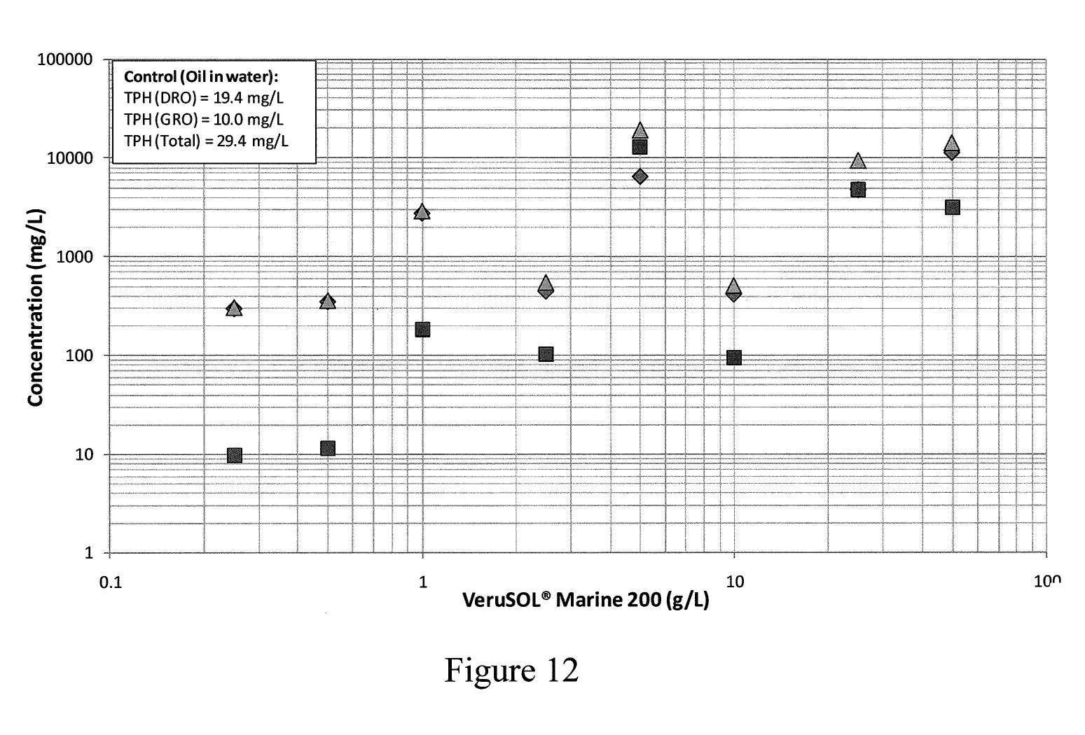

Performance of VeruSOL®-Marine 200 to disperse crude oil was measured using VOCs, SVOCs and TPH (GRO) and TPH (DRO). Results of TPH (GRO), TPH (DRO) and Total TPH (measured as the GRO+DRO total) are presented in FIG. 12. Briefly, VeruSOL® Marine 200, water with 34.6 g/L Instant Ocean, and 5 g of Crude Oil were added to a series of 500 mL flasks and capped. Reactors were shaken for 72 hours at 120 rpm. Reactors were fitted with a draining cap (sealed) and were left to settle upside down for 1 hour. The emulsion phase was drained from the bottom and sampled, keeping any settled oil phase in the jar. The emulsion phase was sent to a third party NELAC approved analytical laboratory for analysis: TPH Method 8015.

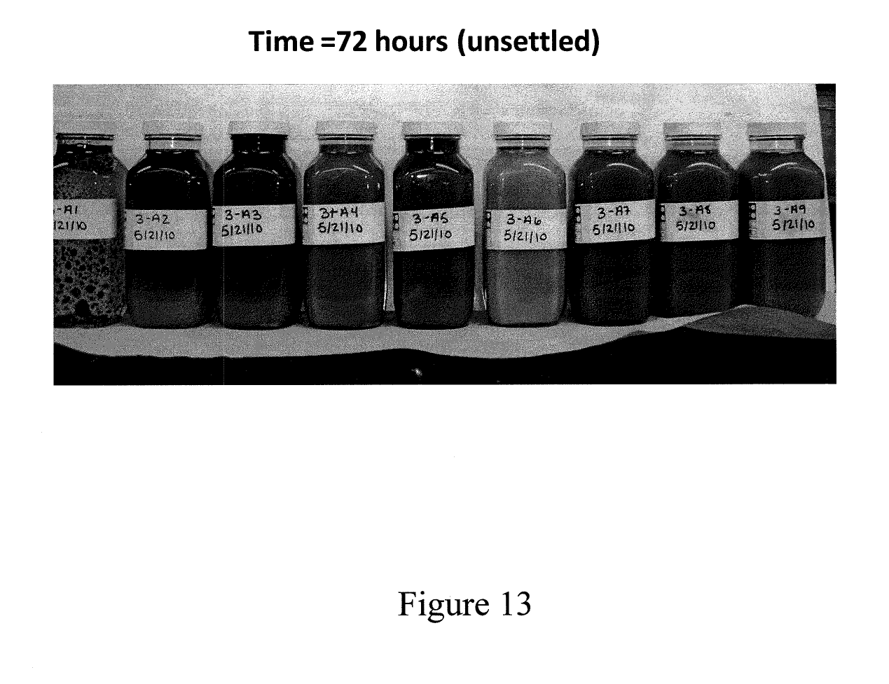

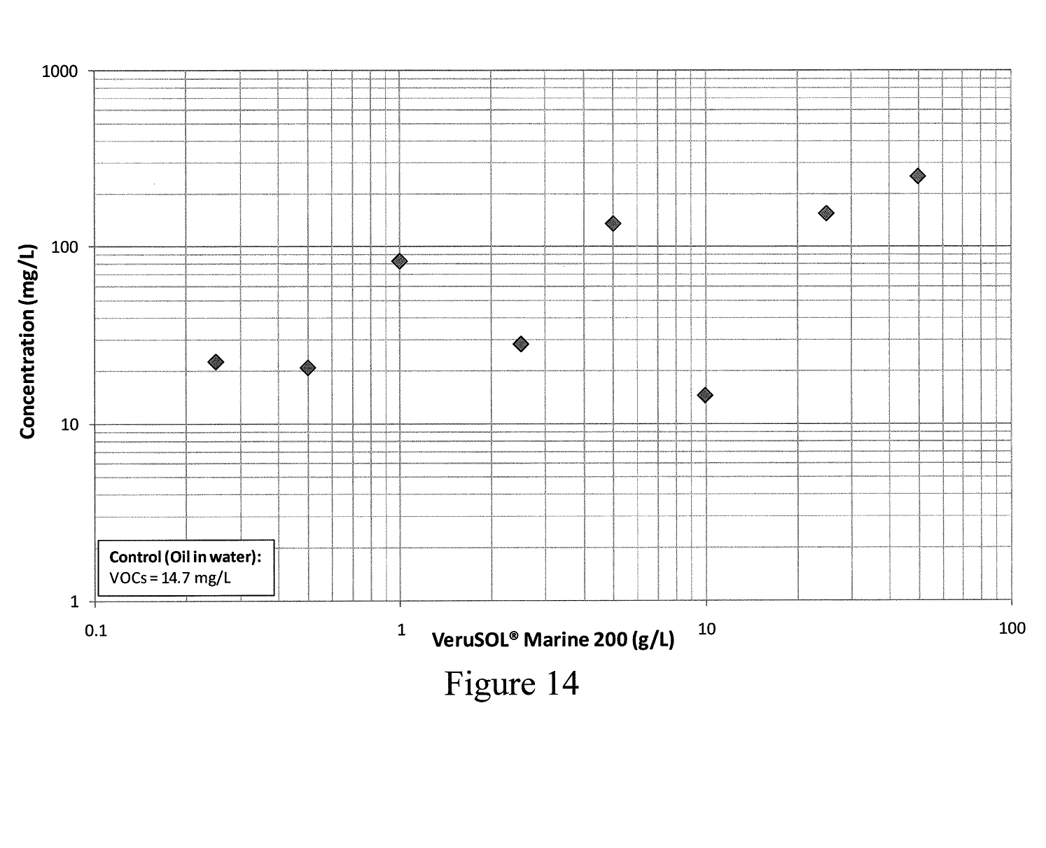

It can be seen that maximum emulsification of the crude oil, as measure by TPH was 19.4 g/L which is greater than the total maximum possible to be emulsified at a concentration of 5 g/L, slightly greater than the CMC for this surfactant system. Examination of the GRO concentration of 13.0 g/L at 5 g/L appears to be an outlier compared to the GRO concentrations emulsified at 2.5 g/L and 10 g/L. It appears that TPH data reported at the 2.5 g/L and 10.0 g/L VeruSOL®-Marine 200 concentrations could be outliers, given the general trend observed in the remainder of the data. Because these experiments were not replicated, this is only an assumption at this time. Total TPH concentration dissolved in the crude oil plus seawater alone was 0.029 g/L (0.010 g/L GRO and 0.019 g/L DRO), which was similar to the previous control associated with VeruSOL®-Marine tests. A control with VeruSOL®-Marine 200 alone with no crude oil at a concentration of 50 g/L had a TPH of 495 g/L (0.006 g/L GRO and 0.495 g/L DRO). At the 0.5 g/L VeruSOL®-Marine 200 dose, the crude oil emulsified at a TPH of 0.357 g/L (0.011 g/L GRO and 0.345 g/L DRO). The 0.5 g/L dose is below the CMC for this surfactant, but is at the 1:10 dispersant to crude oil ratio. At the 1.0 g/L VeruSOL®-Marine 200 dose, the crude oil emulsified at a TPH of 2.94 g/L (0.186 g/L GRO and 2.75 g/L DRO). The 1.0 g/L dose is still below the CMC for this surfactant. It can be see that until the CMC is reached for this surfactant, that there is little emulsification of the crude oil, but once the CMC concentration of VeruSOL®-Marine 200 is reached nearly all of the crude oil is emulsified. This is a different performing surfactant than the VeruSOL®-Marine, in that there is a threshold concentration that must be reached (i.e., the CMC) before this formulation is effective. This clearly has some advantages and disadvantages for oil spill control applications. A photograph of this series of experiments following the 72 hour mixing period is shown in FIG. 13. Results of analysis for total aromatic hydrocarbon VOC concentrations from the VeruSOL®-Marine 200 performance tests are found in FIG. 14. Briefly, VeruSOL® Marine 200, water with 34.6 g/L Instant Ocean, and 5 g of Crude Oil were added to a series of 500 mL flasks and capped. Reactors were shaken for 72 hours at 120 rpm. Reactors were fitted with a draining cap (sealed) and were left to settle upside down for 1 hour. The emulsion phase was drained from the bottom and sampled, keeping any settled oil phase in the jar. The emulsion phase was sent to a third party NELAC approved analytical laboratory for analysis: VOC Method 8260.

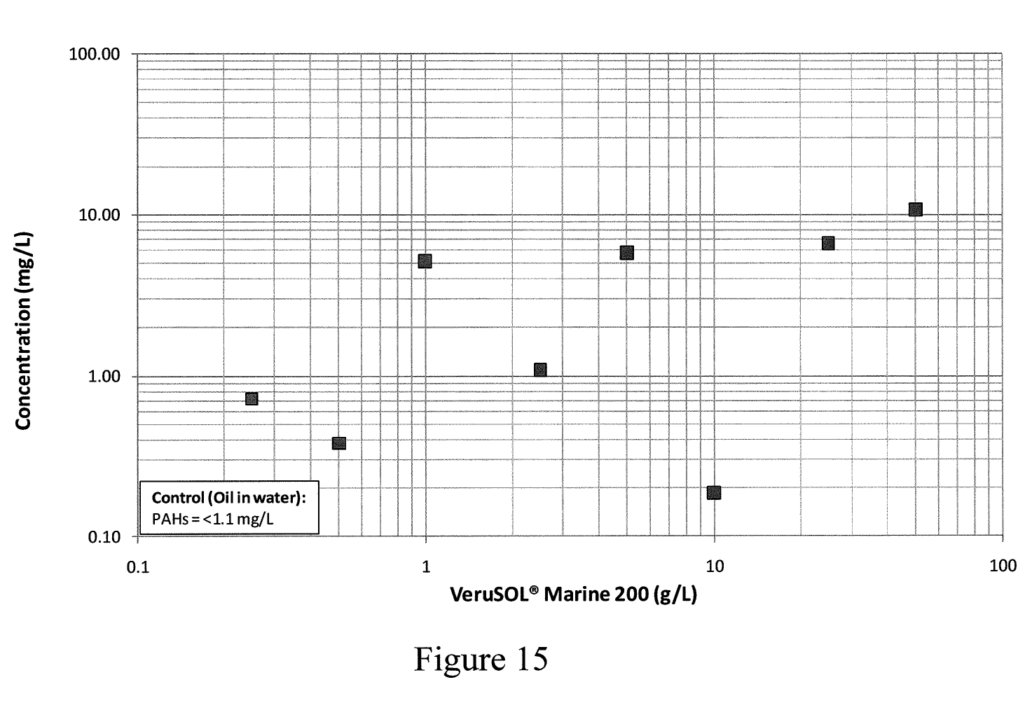

The trend in this aromatic VOC-surfactant concentration relationship is evident with a maximum concentration emulsified concentration of 0.253 g/L at the highest VeruSOL®-Marine 200 concentration used at 50 g/L. A similar trend was observed with total BTEX concentrations. The total emulsified PAH concentrations for the VeruSOL®-Marine 200 emulsion tests are found in FIG. 15. Briefly, VeruSOL® Marine 200, water with 34.6 g/L Instant Ocean, and 5 g of Crude Oil were added to a series of 500 mL flasks and capped. Reactors were shaken for 72 hours at 120 rpm. Reactors were fitted with a draining cap (sealed) and were left to settle upside down for 1 hour. The emulsion phase was drained from the bottom and sampled, keeping any settled oil phase in the jar. The emulsion phase was sent to a third party NELAC approved analytical laboratory for analysis. Naphthalene is included in total was detected using Method 8260, while all other PAHs were detected by Method 8270.

Again, a similar trend was observed with the maximum emulsified concentration of Total PAHs of 0.011 g/L occurring at the highest surfactant concentration used.

### Toxicity Testing

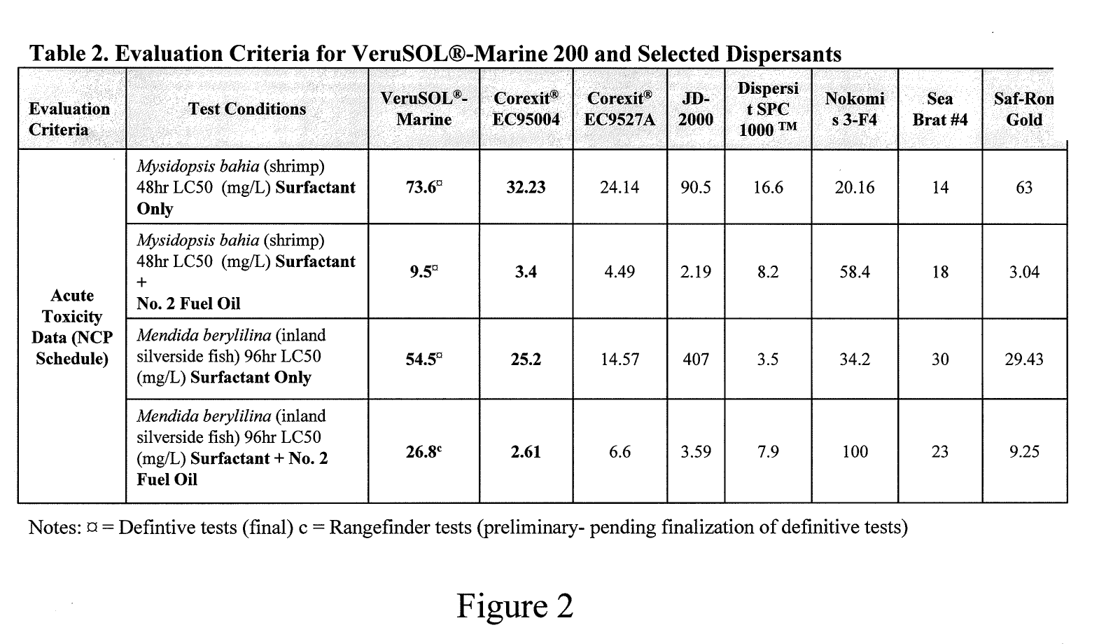

Toxicity tests on VeruSOL®-Marine 200 was conducted as specified in Appendix C, Section 3.0 of the NCP, by PBS&J, 888 West Sam Houston Parkway, South, Suite 110, Houston, Tex. 77042-1917. Aquatic toxicity test results for VeruSOL®-Marine 200 are found in Table 2 (FIG. 2). For VeruSOL®-Marine 200 alone, the 48 hr LC50 aquatic toxicity for Mysidopsis bahia was 73.6 mg/L. This has a considerably greater 48 hr LC50 concentration than VeruSOL®-Marine. This concentration is more than twice that of Corexit® surfactants that are on the NCP list of approved dispersants indicating a much lower aquatic toxicity.

Additional surfactants that are the least toxic on the NCP, as identified by British Petroleum (BP) in a recent communication to USEPA, are also identified in Table 2. In comparison to the dispersants identified by BP as the with the least aquatic toxicity concentrations, VeruSOL®-Marine 200 alone has the next to lowest 48 hr LC₅₀ value. The preliminary, range finder 48 hr LC₅₀ aquatic toxicity concentration when VeruSOL®-Marine 200 was added to No. 2 Fuel Oil, as specified in the NCP aquatic toxicity procedures, was 9.5 mg/L which is higher (indicating lower toxicity) than the two Corexit® surfactants. The 96 hr LC₅₀ aquatic toxicity concentration for Mendida berylilina was 54.5 mg/L for VeruSOL®-Marine 200. This is a much higher concentration (indicating lower toxicity) in comparison to reported values for Corexit® EC9500A at 25.2 mg/L and for Corexit® EC9527A at 14.57 mg/L. This concentration is lower than all the other dispersants listed in Table 2, except one. However, when mixed with No. 2 Fuel oil, the 96 hr LC50 toxicity concentration for the Mendida berylilina was 26.8 mg/L, The mixture of VeruSOL®-Marine 200 with No. 2 Crude Oil reflects a substantially lower 96 hr LC50 toxicity for the Mendida berylilina at 26.8 mg/L, compared to 2.61 mg/L for Corexit® EC9500A and 6.6 mg/L for Corexit® EC9527A. It is apparent that when VeruSOL®-Marine 200 is mixed with No. 2 Fuel Oil, as specified in the NCP the aquatic toxicity is lower in comparison to all other dispersants with one exception.

### Summary

VeruSOL®-Marine 200 is a formulation that contains no solvents (other than water), petroleum products or alcohols. It is made of a single non-ionic plant oil-based surfactant and a decylglucoside-based non-ionic based surfactant and is made isotonic with the marine environment, as needed. Performance results for VeruSOL®-Marine 200 indicate excellent emulsification of the USEPA Reference South Louisiana crude oil once the CMC concentration of 3.1 g/L is achieved. At very low concentrations of VeruSOL®-Marine 200, for example at 0.5 g/L, there is little emulsification of the crude oil that takes place. This increases to approximately 30% emulsification at a 1.0 g/L VeruSOL®-Marine 200 concentration. At the 1.0 g/L VeruSOL®-Marine 200 concentration, with 2.94 g/L TPH emulsified, the oil emulsified to dispersant is 2.94:1. Once the CMC of VeruSOL®-Marine 200 is achieved virtually all of the crude oil is emulsified. VeruSOL®-Marine 200 results in a relatively unstable emulsion with crude oil that floats to the surface, as indicated by zeta potential measurements with particle sizes in the 100 nm to 700 nm size range.

For VeruSOL®-Marine 200 alone, the 48 hr LC50 aquatic toxicity for Mysidopsis bahia was 73.6 mg/L. This concentration is more than twice that of the Corexit® surfactants that are on the NCP list of approved dispersants indicating a much lower aquatic toxicity. The 96 hr LC50 aquatic toxicity concentration for Mendida berylilina was 54.5 mg/L for Formulation 2. This is a much higher concentration (indicating lower toxicity) in comparison to reported values for Corexit® EC9500A at 25.2 mg/L and for Corexit® EC9527A at 14.57 mg/L. When VeruSOL®-Marine 200 is mixed with No. 2 Fuel oil, the 96 hr LC50 toxicity concentration for the Mendida berylilina was 26.8 mg/L, which is a greater concentration (i.e. lower toxicity) than Corexit® EC9500A at 2.61 mg/L and for Corexit® EC9527A at 6.6 mg/L.

### Example 3

### Formulation-Type 3—VeruSOL®-Marine 300

VeruSOL®-Marine 300 is manufactured by VeruTEK® Technologies, Inc., 65 West Dudley Town Road, Bloomfield, Conn., USA (860) 242-9800. VeruSOL®-Marine 300 contains no chlorinated or non-chlorinated solvents (other than water) and contains no alcohols. The maximum and minimum storage temperatures are 43° C. and 5° C. The optimum temperature range of this product is 10° C. to 40° C. There is no known temperature within the maximum and minimum storage temperature that would cause phase separation, chemical changes or other known alterations to the effectiveness of the product. This product has no known limitations to shelf life and will not degrade over time. The composition of VeruSOL®-Marine 300 is mixture of two nonionic decylglucoside crosspolymer surfactants (Poly Suga Mulse D3 and Poly Suga Mulse D7), recently developed (CAS Registry and TSCA Chemical Substances Inventory pending) with each component in the 25%-65% concentration range in an concentrate.

### Physiochemical Performance Results

Pure VeruSOL®-Marine 300 was analyzed for VOCs, Pesticides, PCBs and heavy metals by a third party NELAC Certified Laboratory. All VOCs were below reporting limits of 570 ppm. Concentrations reported for all PCBs analyzed using EPA Method 8082A were below reporting limits of 900 μg/kg. Pesticides concentrations analyzed using EPA Method 8081B were all reported below reporting limits varying from 46 μg/kg to 99 μg/kg. Metals analysis for arsenic was below reporting limits of 0.6 mg/kg, cadmium was detected at 0.011 mg/kg, lead was below reporting limits of 0.3 mg/kg, nickel was detected at 0.17 mg/kg, chromium was detected at 0.19 mg/kg, copper was detected at 0.31 mg/kg, zinc was detected at 0.6 mg/kg, total cyanide was less than 0.97 mg/kg and mercury was below reporting limits of 0.034 mg/kg. VOCs, Pesticide, PCB and heavy metal analyses were conducted by Mitkem Laboratories of Warwick, R.I. The Flash point is greater than 201° F., the Pour Point is 34° F., the specific gravity at 60° F. is 1.1505, and pH was 7.3. All physical characteristics were measured by Mt.Tom Generating Co.LLC Analytical Laboratory of Agawam, Mass.

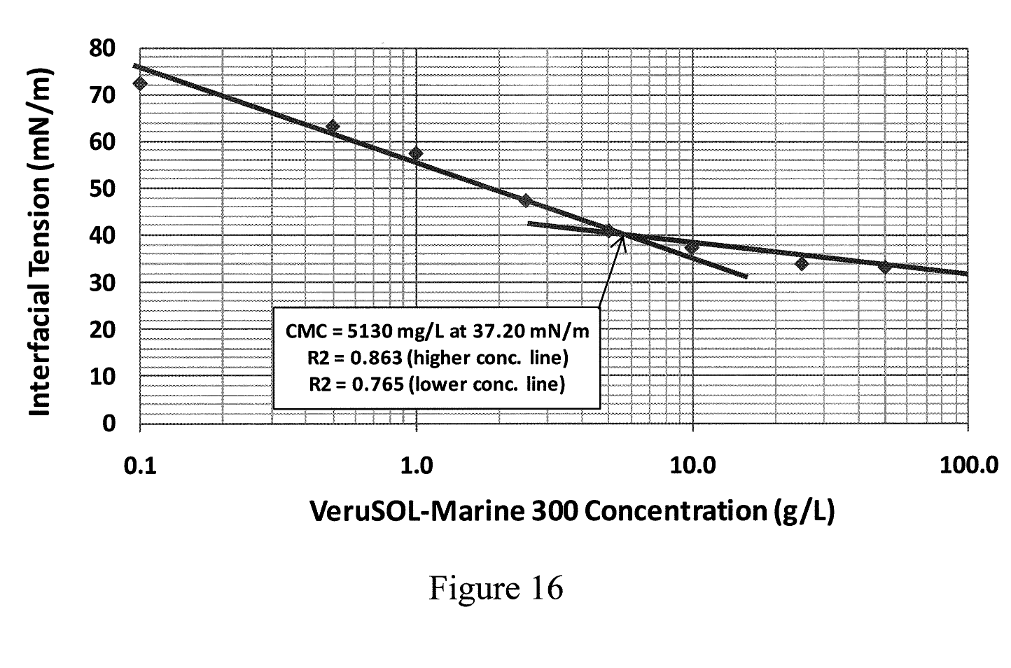

Physical characterization was conducted with varying concentrations of VeruSOL®-Marine 300 to measure IFT and micelle particle size, in a surfactant-water alone mixture. Briefly, tests were conducted at various surfactant concentrations with 34.6 g/L Instant Ocean. Critical Micelle Concentration (CMC) were calculated by intersection of two linear regression lines of best fit. Each reactor with crude oil mixed in at various of VeruSOL®-Marine 300 concentrations was shaken for 24 hours (unlike 72 hours for the other two of VeruSOL®-Marine formulations) to expedite production of these results. Results plotted in FIG. 16 on a log-normal plot indicate a Critical Micelle Concentration (CMC) of 5,130 mg/L at an IFT of 37.2 mN/m. The CMC for VeruSOL®-Marine 300 is more than a factor of 10 greater than that measured with VeruSOL®-Marine. As expected the CMC concentration and interfacial tension are greater than that of Corexit® 9527 of 382.9 mg/L, and 23 mN/m.

Various concentrations of VeruSOL®-Marine 300 were used in the modified shaker flask method with 5 g of USEPA Reference South Louisiana crude oil and approximately 500 mL seawater. Therefore, the maximum concentration of crude oil that could be dispersed is 10 g/L. This maximum concentration is much greater than the maximum concentration that could potentially dissolved in the NCP Swirling Flask Dispersant Effectiveness Test is 636.4 mg/L, which is unrealistically low for an actual oil spill.

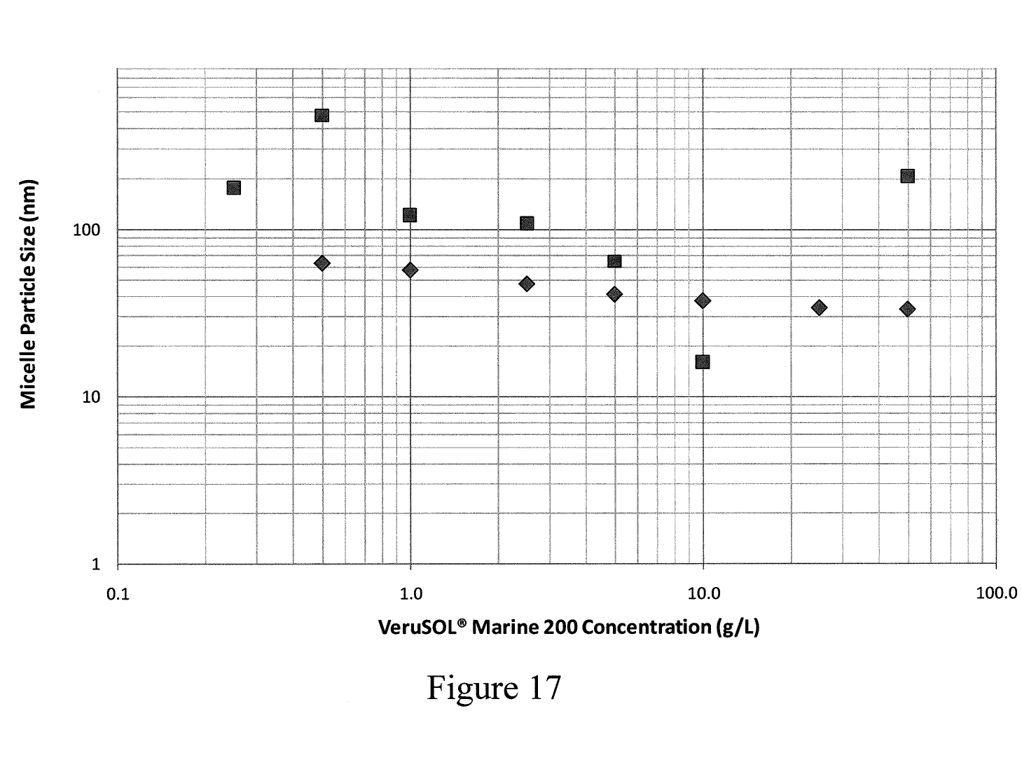

Particle size analysis of the crude oil—VeruSOL®-Marine 300 emulsion is shown in FIG. 17 and is compared to the particle size analyses of VeruSOL®-Marine 300 alone in seawater. Briefly, VeruSOL® Marine 300, water with 34.6 g/L Instant Ocean, and 5 g of Crude Oil were added to a series of 500 mL flasks and capped. Reactors were shaken for 24 hours at 120 rpm. Reactors were fitted with a draining cap (sealed) and were left to settle upside down for 1 hour. The emulsion phase was drained from the bottom and sampled, keeping any settled oil phase in the jar. Particle size analysis was conducted with the Malvern Zetasizer Nano ZS dynamic light scattering laser.

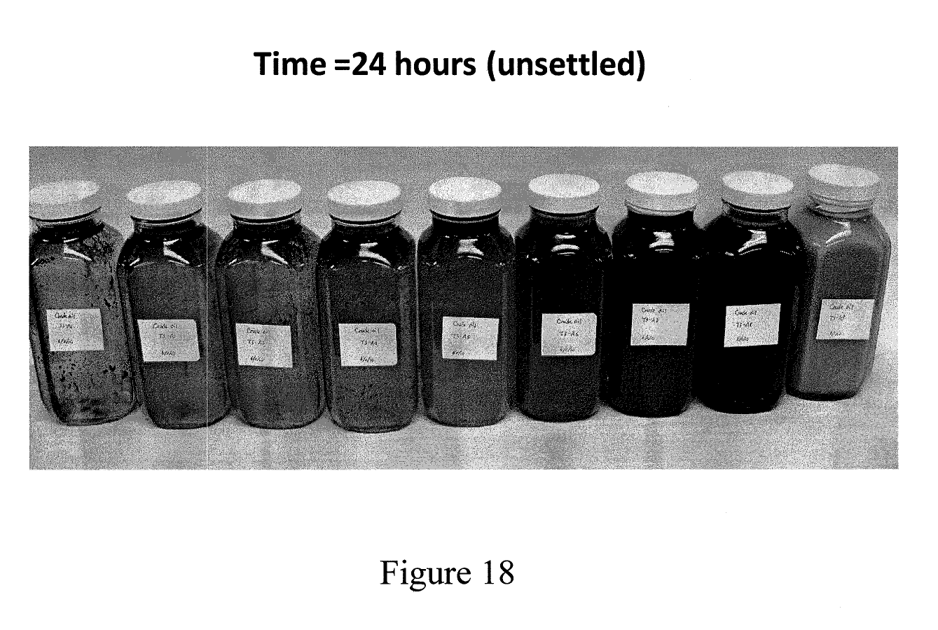

It is evident that the particle size of VeruSOL®-Marine 300 alone in seawater has the smallest particle size of each of the three VeruSOL®-Marine mixtures tested here. Samples generated for the crude oil-VeruSOL®-Marine mixtures were mixed for 24 hours followed by a one-hour settling period. Particle size measurements for VeruSOL®-Marine 300 alone in sea water were in the 20 nm to 70 nm size range. Zeta potential measurements, not all reported here, were typically in the −1 to −9 mV range in the crude oil-VeruSOL®-Marine 300 mixtures indicating relatively unstable suspensions. Suspensions were observed to rise during settling, revealing a suspension that would not sink. Interestingly, the zeta potential of a 50 g/L VeruSOL®-Marine 300 solution with crude oil was −1.01 mV, indicating that the highest VeruSOL®-Marine 300 concentration was also the most unstable. It is evident that examination of FIG. 18 in the photograph of this series of experiments following the 24 hour mixing period is shown reveal complete dissolution of the crude oil in the 10 g/L, 25 g/L and 50 g/L reactors which all have VeruSOL®-Marine 300 above the reported CMC.

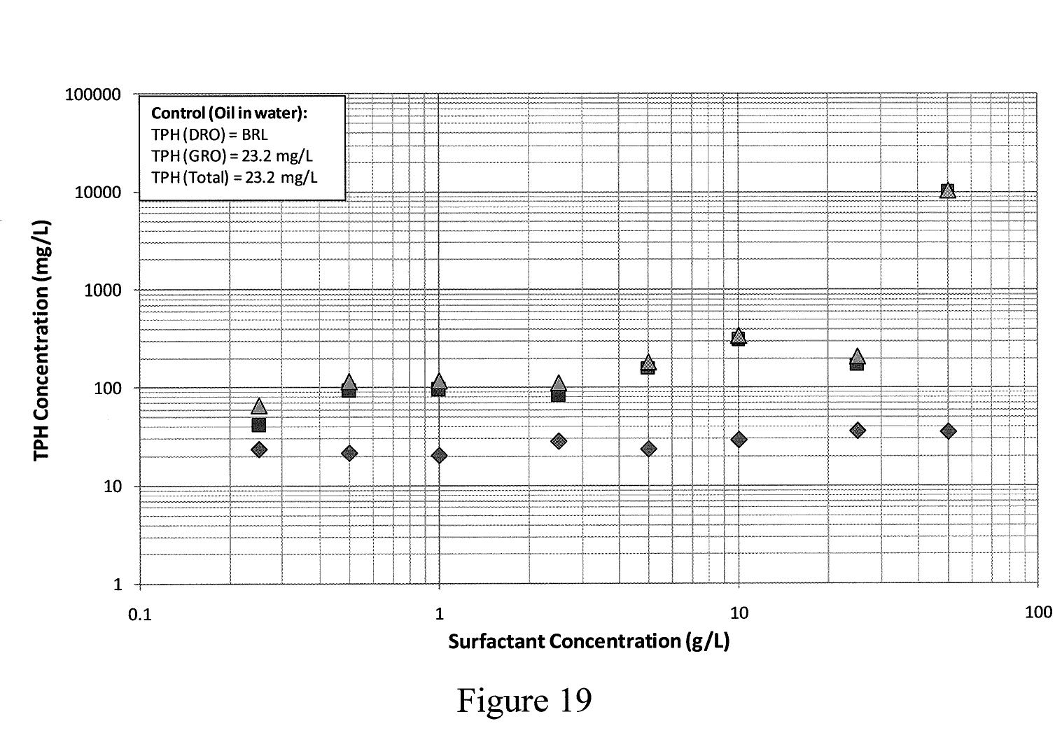

Performance of VeruSOL®-Marine 300 to disperse crude oil was measured using VOCs, SVOCs and TPH (GRO) and TPH (DRO). Results of TPH (GRO), TPH (DRO) and Total TPH (measured as the GRO+DRO total) are presented in FIG. 19. Briefly, VeruSOL® Marine 300, water with 34.6 g/L Instant Ocean, and 5 g of Crude Oil were added to a series of 500 mL flasks and capped. Reactors were shaken for 24 hours at 120 rpm. Reactors were fitted with a draining cap (sealed) and were left to settle upside down for 1 hour. The emulsion phase was drained from the bottom and sampled, keeping any settled oil phase in the jar. The emulsion phase was sent to a third party NELAC approved analytical laboratory for analysis: TPH Method 8015.

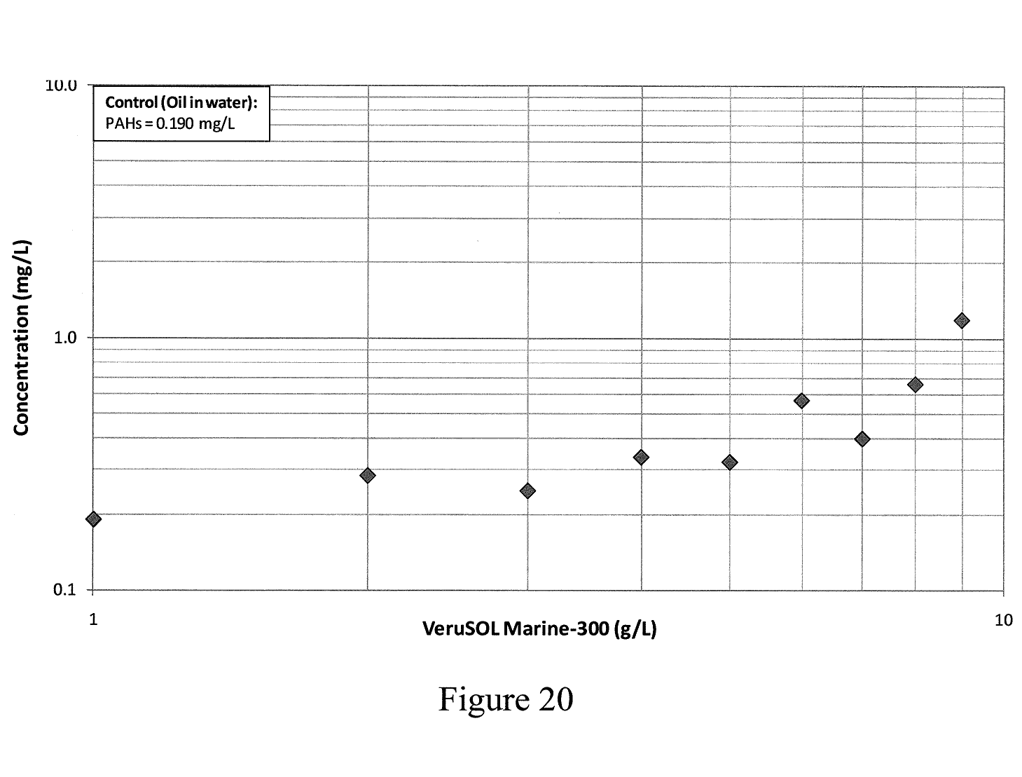

It can be seen that maximum emulsification of the crude oil, as measure by TPH was 10.2 g/L which is equal to the total maximum possible to be emulsified at a concentration of 50 g/L. Examination of the TPH (GRO) concentrations emulsified over the range of VeruSOL®-Marine 300 concentrations indicates minimal TPH (GRO) emulsification. Emulsification of TPH (DRO) dramatically increases at the 50 g/L concentration at which virtually all of the crude oil is emulsified. Unlike VeruSOL®-Marine and VeruSOL®-Marine 200, VeruSOL®-Marine 300 has the characteristic of forming a water-in-oil emulsion with the crude oil emulsion floating on the surface of the water with minimal solubilization. This clearly has some advantages and disadvantages for oil spill control applications, where crude oil emulsification is desirable but also with the ability to separate the crude oil emulsion using oil-water separator methods. The total emulsified PAH concentrations for the VeruSOL®-Marine 300 emulsion tests are found in FIG. 20. Briefly, VeruSOL® Marine 300, water with 34.6 g/L Instant Ocean, and 5 g of Crude Oil were added to a series of 500 mL flasks and capped. Reactors were shaken for 24 hours at 120 rpm. Reactors were fitted with a draining cap (sealed) and were left to settle upside down for 1 hour. The emulsion phase was drained from the bottom and sampled, keeping any settled oil phase in the jar. The emulsion phase was sent to a third party NELAC approved analytical laboratory for analysis: SVOCs Method 8260.

Consistent with the TPH (GRO) results for VeruSOL®-Marine 300, there is minimal solubilization of PAH compounds over the entire range of concentrations tested with a maximum concentration of 11.8 mg/L solubilized at 50 g/L. Again, the benefits of this formulation is very low aquatic toxicity, with minimal solubilization of the crude oil in the bulk aqueous phase, but complete emulsification of the crude oil at the 50 g/L VeruSOL®-Marine 300 concentration.

### Toxicity Testing

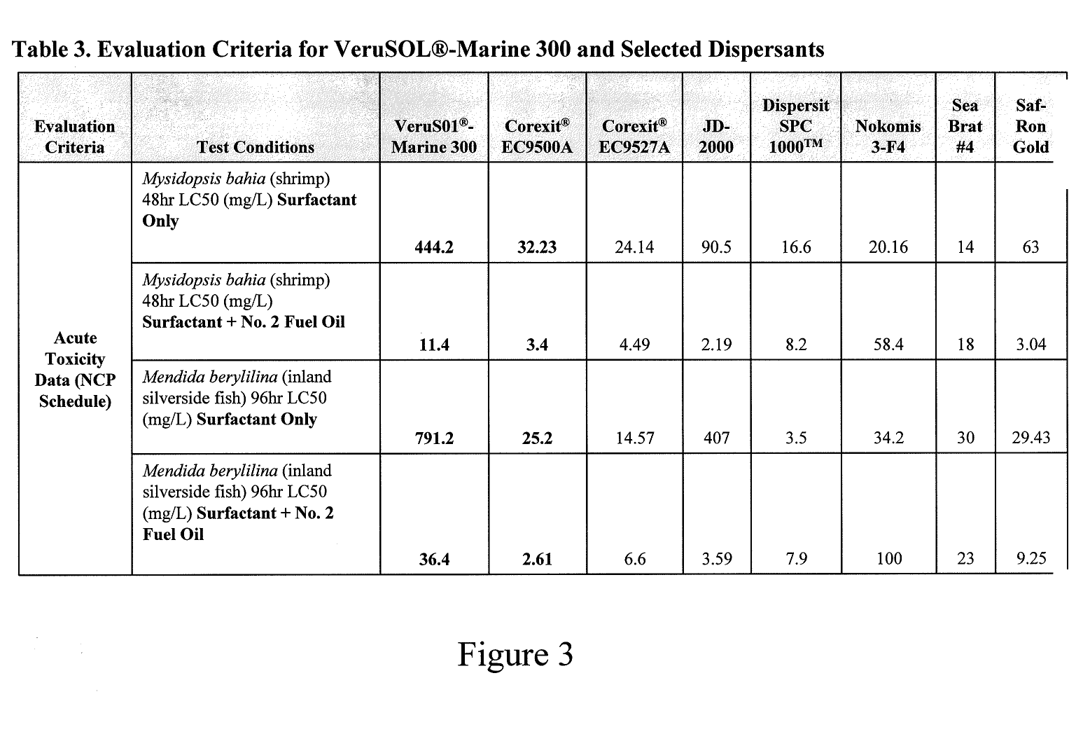

Toxicity tests on VeruSOL®-Marine 300 were conducted as specified in Appendix C, Section 3.0 of the NCP, by PBS&J, 888 West Sam Houston Parkway, South, Suite 110, Houston, Tex. 77042-1917. Aquatic toxicity test results for VeruSOL®-Marine are found in Table 3 (FIG. 3). For VeruSOL®-Marine 300 alone, the 48 hr LC50 aquatic toxicity for Mysidopsis bahia was 444.2 mg/L. This has a considerably greater 48 hr LC50 concentration than VeruSOL®-Marine. This concentration is more than four times that of any other dispersant reported in Table 3, indicating a much lower aquatic toxicity. The 48 hr LC₅₀ aquatic toxicity concentration for Mysidopsis bahia with the VeruSOL®-Marine 300 alone in sea water was a factor of 13 and 18 greater in comparison to Corexit® EC9500A and Corexit® EC9527A, respectively.

The 48 hr LC₅₀ aquatic toxicity concentration when VeruSOL®-Marine 300 was added to No. 2 Fuel Oil, as specified in the NCP aquatic toxicity procedures, was 11.4 mg/L which is more than twice as large as for the two Corexit® surfactants. 96 hr LC₅₀ toxicity tests for the Mendida berylilina (inland silverside fish) with VeruSOL®-Marine 300 alone was 791.2 mg/L. This concentration was greater than the dispersants on the NCP listed in Table 3. Additionally, when mixed with No. 2 Fuel oil, the 96 hr LC₅₀ toxicity concentration for the Mendida berylilina was 36.4 mg/L, which is a greater concentration than all but one other dispersant on the NCP. The mixture of VeruSOL®-Marine 300 with No. 2 Crude Oil reflects a substantially lower 96 hr LC₅₀ toxicity for the Mendida berylilina at 36.4 mg/L, compared to 2.61 mg/L for Corexit® EC9500A and 6.6 mg/L for Corexit® EC9527A. It is apparent that when VeruSOL®-Marine 300 is mixed with No. 2 Fuel Oil, as specified in the NCP the aquatic toxicity is lower in comparison with all other dispersants.

### Summary

VeruSOL®-Marine 300 is a formulation that contains no solvents (other than water), petroleum products or alcohols. It is made of two decylglucoside-based nonionic alkyl glucoside crosspolymer surfactant and is made isotonic with the marine environment, as needed. Performance results for VeruSOL®-Marine 300 indicate excellent emulsification of the USEPA Reference South Louisiana crude oil once the CMC concentration of 5.13 g/L is achieved. At very low concentrations of VeruSOL®-Marine 300, there is little emulsification of the crude oil that takes place. Once the CMC of VeruSOL®-Marine 300 is achieved virtually all of the crude oil is emulsified. VeruSOL®-Marine 300 results in a relatively unstable emulsion with crude oil that floats to the surface, as indicated by zeta potential measurements with particle sizes in the 10 nm to 400 nm size range.

For VeruSOL®-Marine 300 alone, the 48 hr LC50 aquatic toxicity for Mysidopsis bahia was 444.2 mg/L. This concentration is more than double that of any other dispersant reported in this document, indicating a much lower aquatic toxicity. The 48 hr LC50 aquatic toxicity concentration for Mysidopsis bahia with the VeruSOL®-Marine 300 alone in sea water is a factor of 12 and 18 greater in comparison to Corexit® EC9500A and Corexit® EC9527A, respectively. Preliminary range finder 96 hr LC50 toxicity tests for Mendida berylilina (inland silverside fish) with VeruSOL®-Marine 300 alone was 791.2 mg/L. This concentration indicates that this product is safer to marine organisms than the other dispersants listed in the NCP and reported in this document.

### Example 4

### Hydrogen Peroxide Containing Formulations—VeruSOLVE-Marine 200HP

The composition of VeruSOL®-MarineHP is mixture of a single nonionic ethoxylated surfactant, Ethoxylated Coconut Fatty Acid, CAS No. 61791-29-5; and a decylglucoside surfactant (Poly Suga Mulse D3), recently developed (CAS Registry and TSCA Chemical Substances Inventory pending) with each component in the 25%-65% concentration range in a concentrate. The formulation has added hydrogen peroxide at a concentration between about 1% and about 4% by weight in a working strength solution. A specific formulation is given in the following table.

| Component | % Wt. | Avg % |
|---|---|---|
| Water | 85-95% | 91.1% |
| Sorbitan Oleate Decylglucoside Cross Polymer | 1-5% | 2.5% |
| Ethoxylated Coco Fatty Acid | 1-5% | 2.5% |
| Hydrogen Peroxide | 1-4% | 3.9% |

### Physiochemical Performance Results

Physicochemical properties were analyzed as discussed above.

### Physical Properties

1. Flash Point (ASTM D-56): >93 C
2. Pour Point (ASTM D-97): +18 F
3. Viscosity (ASTM D-445): 1.77391 cst @ 40 C
4. Specific Gravity (ASTM D1298): 1.017 @ 60 F
5. pH (ASTM D-1293): 7.01
6. Surface Active Agents: Nonionic Surfactants
7. Solvents: None
8. Additives: None
9. Solubility in Water: Miscible in oil, water, and solvents

### Analysis for Heavy Metals and Chlorinated Hydrocarbons

| COMPOUND | CONCENTRATION (mg/L) |
|---|---|
| Arsenic | 0.0025 |
| Cadmium | <0.0010 |
| Chromium | 0.0326 |
| Copper | 0.0093 |
| Lead | <0.0020 |
| Nickel | 0.0077 |
| Zinc | 0.0165 |
| Cyanide | <0.010 |
| Chlorinated Hydrocarbons | <0.025 |
| Mercury | 0.00109 |

Method 601 (GC Screen) was run and unknowns were found. As per Method 601 protocol, Method 624 was used for follow-up determinations. Section 1.2 of the Method 601 clearly dictates that for non-wastewater sample and unknowns, that Method 624 should be run to definitively qualify Chlorinated Hydrocarbons for the sample. For Pesticide and PCB analysis was performed by method 608.

### Toxicity Testing

| | | LC50 |
|---|---|---|
| MATERIAL TESTED | SPECIES | (PPM) |
| Product | Menidia beryllina | 418.32 |
| | Mysidopsis bahia | 76.98 |
| No. 2 Fuel Oil | Menidia beryllina | 13.36 |
| | Mysidopsis bahia | 1.94 |
| Product & No. 2 Fuel Oil | Menidia beryllina | 10.67 |
| | Mysidopsis bahia | 2.51 |
| Reference Toxicant: | Menidia beryllina | 13.36 |
| (Sodium Laurel Sulfate) | Mysidopsis bahia | 12.08 |

### Example 5

### Cosolvent-Containing Formulations

Cosolvent-containing formulations contain no chlorinated solvents, petroleum or petroleum derived compounds, and contains no alcohols. The maximum and minimum storage temperatures are 43° C. and 5° C. The optimum temperature range of this product is 10° C. to 40° C. There is no known temperature within the maximum and minimum storage temperature that would cause phase separation, chemical changes or other known alternations to the effectiveness of the product. This product has no known limitations to shelf life and will not degrade over time.

A composition may have, for example, three nonionic ethoxylated surfactants: Ethoxylated Castor Oil, CAS No. 61791-12-6; Ethoxylated Coconut Fatty Acid, CAS No. 61791-29-5; and Ethoxylated Coconut Amide CAS No. 61791-08-0; Sorbitan Oleate Decylglucoside Cross Polymer—CAS No. 1227096-09-4 with each component in the 5%-40% concentration range, in an concentrate (0.5% to 5% in a working strength solution); citrus terpene in the 0.5% to 5% range, in an working strength solution; and hydrogen peroxide in the 4% to 20% range, in a working strength solution; and water. Specific formulations and percentage of each component, in a working strength solution are given below, are given in the table below.

| Component | % Wt. Range | Specific % |
|---|---|---|
| Water | 80-90% | 86.5% |
| Sorbitan Oleate Decylglucoside | 1-5% | 3% |
| Cross Polymer | | |
| Ethoxylated Castor Oil | 0.5-5% | 0.7% |
| Ethoxylated Coco Fatty Acid | 0.5-5% | 0.7% |
| Ethoxylated Coconut Amide | 0.5-5% | 0.7% |
| Citrus Terpene | 0.5-5% | 0.5% |
| Hydrogen Peroxide | 4-20% | 7.9% |

These components are either Generally Recognized as Safe (GRAS) by the United States Food and Drug Administration the (USFDA) or are approved as indirect food additives and for dermal contact, such as cosmetics. These components were selected based on its USFDA GRAS status, uses as indirect food additive products, biodegradability, compatibility with oxidants, and ability to bring hydrocarbons into an oil-in-water microemulsion versus an oil-water globule mixture.

### Physiochemical Performance Results

Physicochemical properties were analyzed as discussed above.

### Physical Properties

1. Flash Point (ASTM D-56): >93 C
2. Pour Point (ASTM D-97): +18 F
3. Viscosity (ASTM D-445): 1.77391 cst @ 40 C
4. Specific Gravity (ASTM D1298): 1.017 @ 60 F
5. pH (ASTM D-1293): 7.01
6. Surface Active Agents: Nonionic Surfactants
7. Solvents: Citrus terpenes
8. Additives: Hydrogen peroxide
9. Solubility in Water: Miscible in oil, water, and solvents

The particle size analysis of an emulsion is expected to be similar in size range of 100 nm to 700 nm as is the crude oil-VeruSOL®-Marine 200 mixtures in FIG. 11.

### Example 6

### Increased Dispersion of Crude Oil in Water

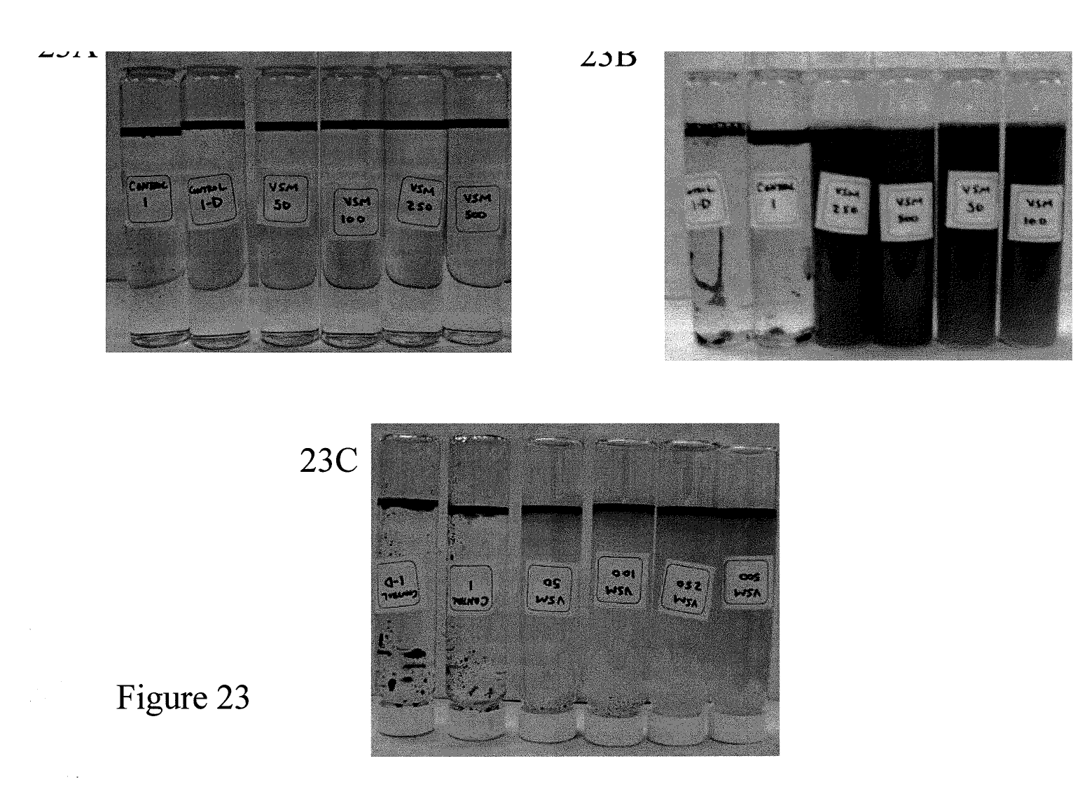

Samples of crude oil suspended on water were treated with increasing concentrations of surfactant composition (VeruSOL-Marine), shaken for 2 hours, and allowed to settle for 2 more hours. The results are shown in FIG. 23. The results show increased dissolution of crude oil into the water layer following treatment. Increased amounts of surfactant composition produced increased amounts of dissolution.

### Example 7

### Cleaning Oil Coated Samples

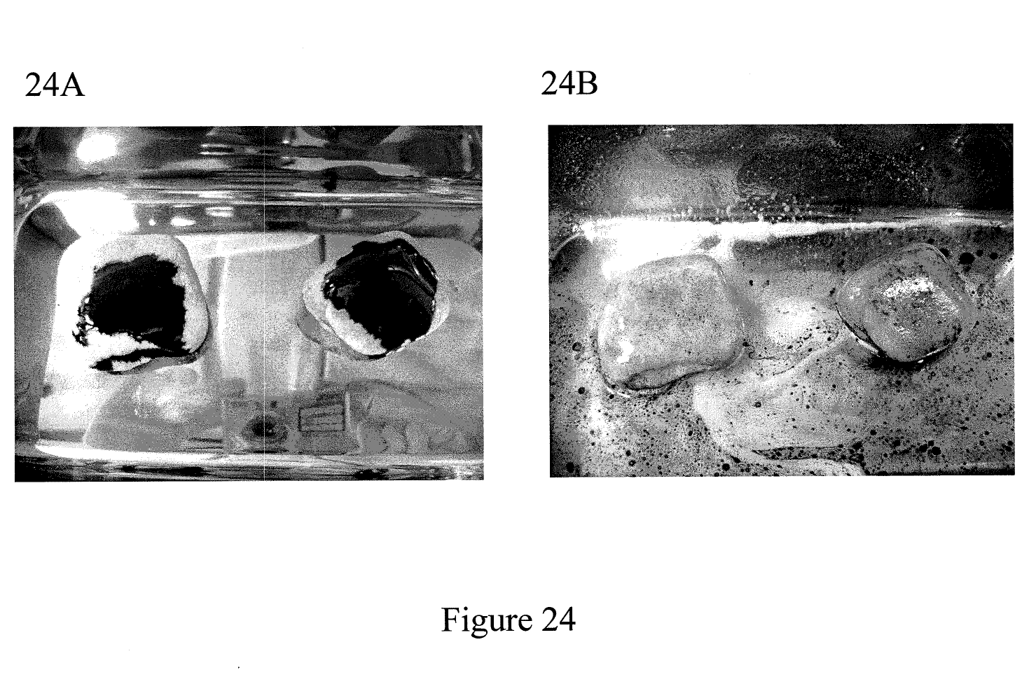

Rocks coated with crude oil were treated with combined surfactant and oxidant composition (VeruSOLV-Marine 200HP). Results (FIG. 24) show rapid dispersal of oil from the surface of the rocks. FIG. 24A shows USEPA reference crude oil on rocks. FIG. 24B shows the rocks 5 minutes following spray treatment with VeruSOLVE™-Marine 200HP and rinsed with a small amount of water.

### Example 8

### Pretreatment

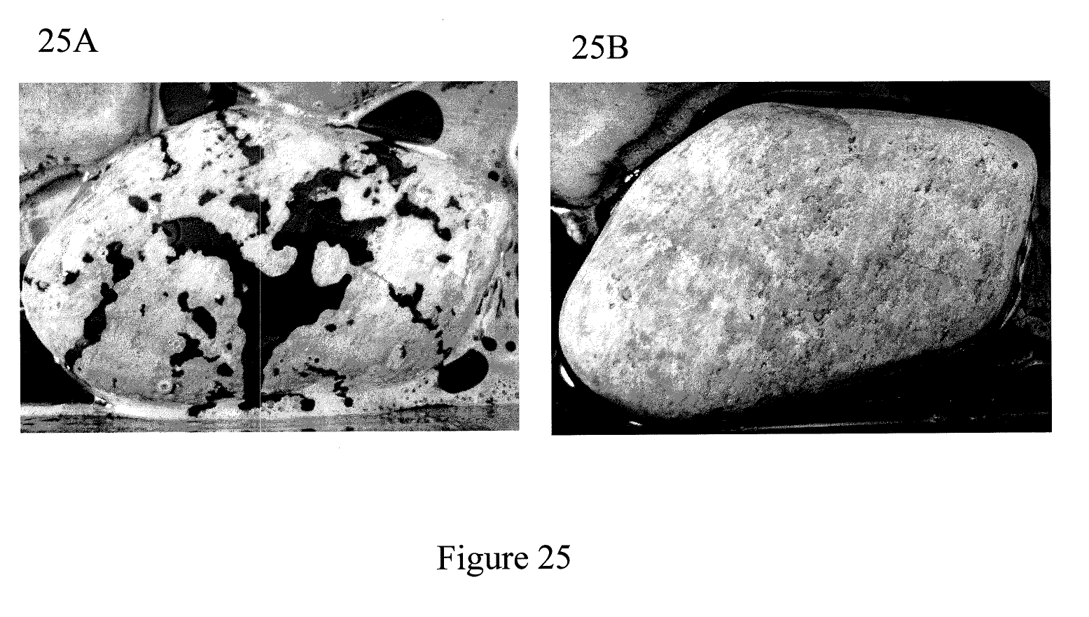

Sample rocks were pretreated with combined surfactant and oxidant composition (VeruSOLV-Marine 200HP). Results (FIG. 25) show a significant decrease in adherence of crude oil to the surface of the rocks. The pretreatment prevents coating and penetration of oils. The rock easily rinses off with one spray of water. FIG. 25A shows a rock pretreated with one spray of VeruSOLVE™-Marine 200HP before applying crude oil. FIG. 25B shows the rock completely clean after one spray of water.

### Example 9

### Treatment and Decomposition of Oil-Contaminated Sand

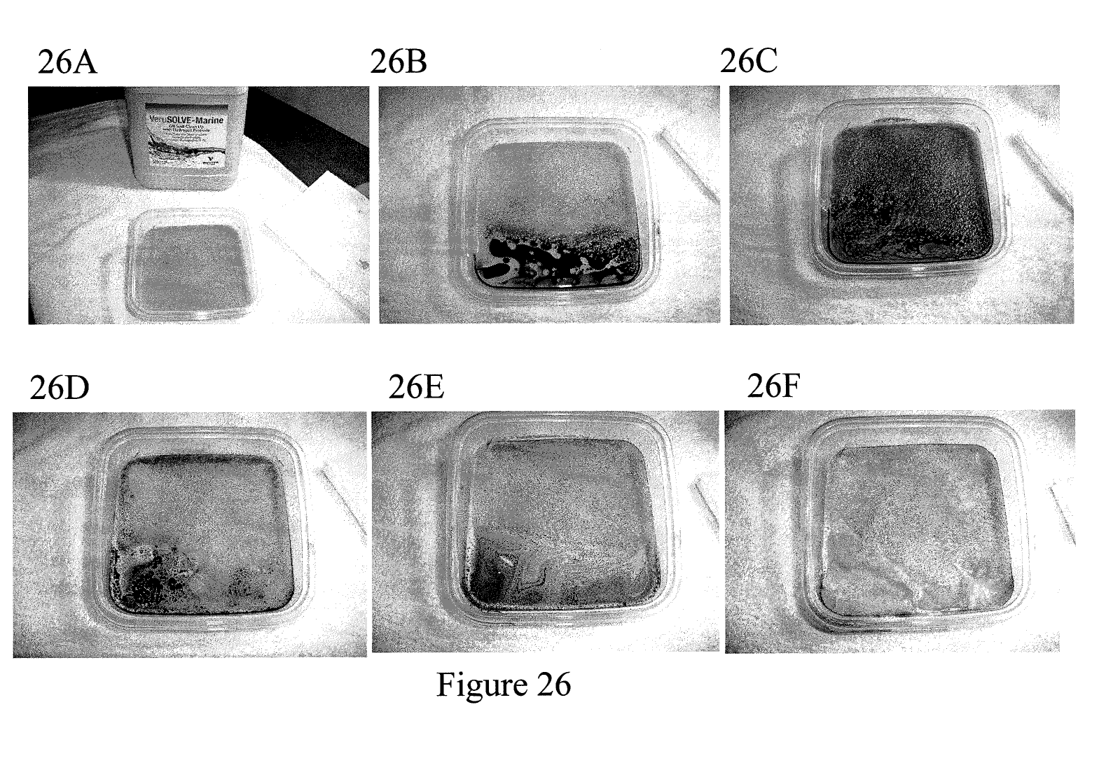

Sand was treated with crude oil suspended on water, producing contaminated sand. Treatment of the contaminated sand with combined surfactant and oxidant composition shows rapid dissolution of the crude oil from the sand, followed by decomposition of the crude oil. Results are shown in FIG. 26. FIG. 26A shows Florida beach sand. FIG. 26B shows crude oil in water added to the beach sand. FIG. 26C shows crude oil soaked into the beach sand. FIG. 26D shows the beach sand immediately after treatment with VeruSOLVE™-Marine 200HP. FIG. 26E shows the beach sand after continued reaction with VeruSOLVE™-Marine 200HP. FIG. 26F shows the beach sand following treatment with VeruSOLVE™-Marine 200HP.

### Example 10

### Treatment of Oil Contaminated Plastic Tank

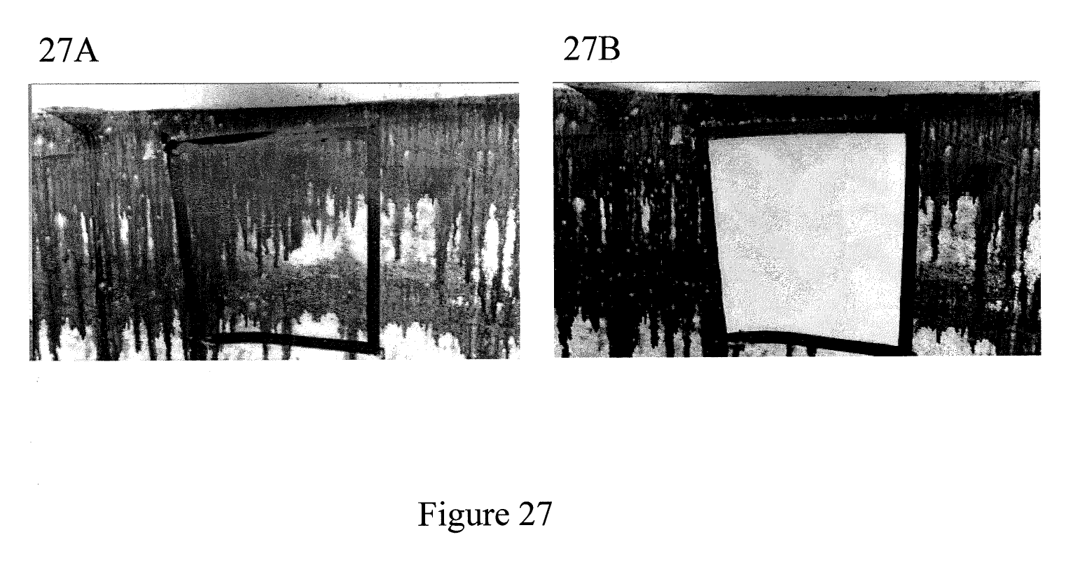

As an example of an object in an oil-spill impacted surface water environment, a 1,000 gallon HDPE tank contaminated with No. 6 oil residue for 7 months was treated with VeruSOLVE™ Marine 200HP. Results are shown in FIG. 27. FIG. 27A shows the tank before treatment. FIG. 27B shows the tank after 5 minutes following spray treatment with VeruSOLVE™-Marine 200HP.

### Example 11

### Treatment of Oil Contaminated Plastic Parts

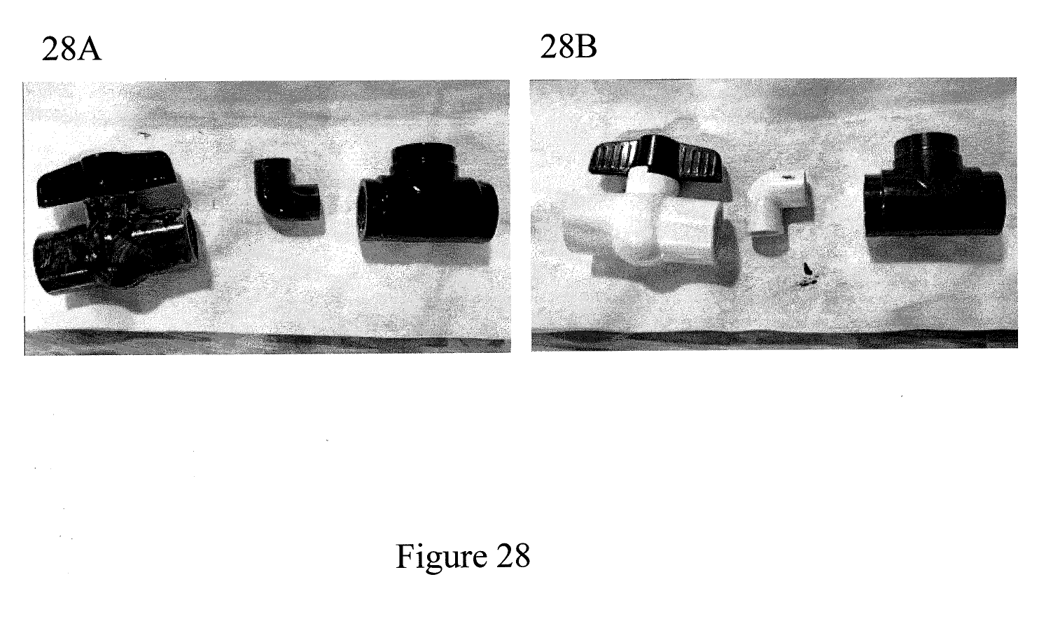

Plastic parts contaminated with No. 6 oil were treated with VeruSOLV™ Results are shown in FIG. 28. FIG. 28A shows the parts before treatment. FIG. 28B shows the parts wiped clean minutes after spray treatment with VeruSOLVE™-Marine 200HP.

The invention has been described and illustrated with reference to certain particular embodiments thereof, those skilled in the art will appreciate that various adaptations, changes, modifications, substitutions, deletions, or additions of procedures and protocols may be made without departing from the spirit and scope of the invention. It is intended, therefore, that the invention be defined by the scope of the claims that follow and that such claims be interpreted as broadly as is reasonable.

We claim:

1. A method for remediating a surface water oil spill comprising:
applying onto an oil-spill impacted surface water environment a biodegradable composition comprising at least one surfactant selected from the group consisting of ethoxylated plant oils, ethoxylated-amidated plant oils, and nonionic alkyl glycoside crosspolymer, in an amount sufficient to remediate the oil spill.

2. The method of claim 1, wherein the environment comprises marine water, estuarine water, freshwater, or wetlands.

3. The method of claim 1, wherein the environment comprises shorelines, beaches, rocks, sand, boats, buoys, bridges, docks, and/or jetties.

4. The method of claim 1, wherein the composition is sprayed onto the surface water environment and the composition is isotonic with the surface water.

5. The method of claim 1, wherein the method further comprises applying an oxidant.

6. The method of claim 5, wherein the oxidant is selected from the group consisting of a persulfate, sodium persulfate, a percarbonate, a peroxide, hydrogen peroxide, and combinations.

7. The method of claim 1 wherein the composition comprises hydrogen peroxide.

8. The method of claim 1, wherein the composition further comprises a biodegradable cosolvent selected from the group consisting of a terpene, a citrus-derived terpene, limonene, d-limonene, and combinations.

9. The method of claim 1, wherein the composition comprises at least one ethoxylated or ethoxylated-amidated plant oil.

10. The method of claim 1, wherein the composition comprises at least two different ethoxylated or ethoxylated-amidated plant oils.

11. The method of claim 1, wherein the composition comprises at least three different ethoxylated or ethoxylated-amidated plant oils.

12. The method of claim 1, wherein the composition comprises a nonionic alkyl glycoside crosspolymer.

13. The method of claim 9, wherein the composition comprises at least two different nonionic alkyl glycoside crosspolymers.

14. The method of claim 1, wherein the composition comprises an ethoxylated or ethoxylated-amidated plant oil, and a nonionic alkyl glycoside crosspolymer.

15. The method of claim 1, wherein at least one surfactant is an ethoxylated or ethoxylated-amidated plant oil, where the plant oil is selected from the group consisting of castor oil, coconut oil, corn oil, sesame oil, almond oil, cottonseed oil, olive oil, palm oil, peanut oil, safflower oil, soybean oil, or rapeseed oil.

16. The method of claim 1, wherein at least one surfactant comprises an alkyl glycoside crosspolymer selected from the group consisting of octylglycoside crosspolymers, decylglycoside crosspolymers, laurylglycoside crosspolymers, tetradecylglycoside crosspolymers, laurylglucoside crosspolymers, decylglucoside crosspolymers, sorbitan oleate decylglucoside crosspolymers, and alkyl glycosides having a hydrophile lipophile balance between 3 and 12.

17. The method of claim 1, wherein the only surfactants in the composition are alkyl glycoside crosspolymers.

18. The method of claim 1, wherein the composition is essentially free of solvent.

19. The method of claim 1, wherein the composition comprises ethoxylated coconut oil, ethoxylated castor oil and ethoxylated-amidified coconut oil.

20. The method of claim 19, wherein the composition further comprises a sorbitan oleate decylglucoside crosspolymer.

21. The method of claim 20, wherein the composition further comprises hydrogen peroxide.

22. The method of claim 1, wherein the composition comprises an ethoxylated coconut oil and a sorbitan oleate decylglucoside crosspolymer.

23. The method of claim 22, wherein the composition further comprises hydrogen peroxide.

24. The method of claim 17, wherein the composition comprises two sorbitan oleate decylglucoside crosspolymers with different hydrophile-lipophile balances.

25. A composition consisting essentially of
water;
a surfactant comprising at least one nonionic alkyl glycoside crosspolymer; and
at least one additive selected from the group consisting of salt, a biodegradable cosolvent, an oxidant, and combinations thereof.

26. The composition of claim 25, comprising salt where the ionic strength of the composition is isotonic with sea or brackish surface water.

27. The composition of claim 25, comprising a biodegradable cosolvent selected from the group consisting of a terpene, a citrus-derived terpene, limonene, d-limonene, and combinations.

28. The composition of claim 25, comprising an oxidant.

29. The composition of claim 25, wherein the oxidant is selected from the group consisting of a persulfate, sodium persulfate, a percarbonate, a peroxide, hydrogen peroxide, ozone, oxygen, and combinations.

30. The composition of claim 25, wherein the oxidant is hydrogen peroxide.

31. The composition of claim 25, wherein the surfactant comprises at least two nonionic alkyl glycoside crosspolymers with different hydrophile-lipophile balances.

32. The composition of claim 25, wherein the surfactant further comprises at least one ethoxylated plant oil or ethoxylated-amidated plant oil.

33. The composition of claim 32, wherein the plant oil is selected from the group of castor oil, coconut oil, corn oil, sesame oil, almond oil, cottonseed oil, olive oil, palm oil, peanut oil, safflower oil, soybean oil, and rapeseed oil.

34. The composition of claim 25, wherein the surfactant further comprises three ethoxylated plant oils or ethoxylated-amidated plant oils.

35. The composition of claim 25, wherein the alkyl glycoside crosspolymer has a hydrophile-lipophile balance between about 3 and about 12.

36. The composition of claim 25, wherein the alkyl glycoside crosspolymer is a sorbitan oleate decylglucoside crosspolymer.

37. The composition of claim 36, wherein the surfactant further comprises a second sorbitan oleate decylglucoside crosspolymer with a different hydrophile-lipophile balance.

38. The composition of claim 36, wherein the surfactant further comprises ethoxylated coconut oil.

39. The composition of claim 38, further comprising hydrogen peroxide.

40. The composition of claim 38, where the surfactant further comprises ethoxylated castor oil and ethoxylated-amidified coconut oil.

41. The composition of claim 40, further comprising hydrogen peroxide.

42. The composition of claim 41, further comprising citrus terpene.

43. A composition consisting essentially of
water;
a surfactant comprising at least one ethoxylated plant oil or ethoxylated-amidated plant oil; and
an additive selected from the group consisting of salt, oxidant, and combinations thereof.

44. The composition of claim 43 wherein the plant oil is selected from the group of castor oil, coconut oil, corn oil, sesame oil, almond oil, cottonseed oil, olive oil, palm oil, peanut oil, safflower oil, soybean oil, and rapeseed oil.

45. The composition of claim 43, comprising salt where the ionic strength of the composition is isotonic with sea or brackish surface water.

46. The composition of claim 43, further comprising an oxidant.

47. The composition of claim 46, wherein the oxidant is hydrogen peroxide.

48. The composition of claim 43, wherein the composition comprises three different ethoxylated plant oil or ethoxylated-amidated plant oil surfactants.

49. The composition of claim 48, wherein the surfactant is a mixture of ethoxylated coconut oils; ethoxylated-amidified coconut oils, and ethoxylated castor oils.

50. The composition of claim 43, wherein the composition is a concentrate suitable for dilution to working strength for applying to an oil spill.

51. The composition of claim 43, wherein the composition is a working strength solution suitable for applying directly to an oil spill.
